(19) United States
(12) Patent Application Publication
(10) Pub. No.: US 2014/0094293 A1
(43) Pub. Date: Apr. 3, 2014

(54) MULTI-STAKE, MULTI-LEVEL PROGRESSIVE WITH OVERLAPPING ELIGIBILITY BANDS

(71) Applicant: IGT, Reno, NV (US)

(72) Inventor: Mark C. Nicely, Daly City, CA (US)

(73) Assignee: IGT, Reno, NV (US)

(21) Appl. No.: 13/631,461

(22) Filed: Sep. 28, 2012

(51) Int. Cl. A63F 13/00

(52) U.S. Cl. 463/27

(57) ABSTRACT

Disclosed herein are techniques and equipment for providing a multi-stake, multi-level progressive jackpot ladder with overlapping eligibility bands. In such a jackpot ladder, multiple wager sizes may be eligible to participate, with each wager size associated with a grouping of jackpot levels in the jackpot ladder.

### TECHNICAL FIELD

The present disclosure relates generally to wager-based gaming machines and systems, and more specifically to multi-level progressive jackpot systems for use with wager-based gaming systems.

### BACKGROUND

Entities offering wager gaming may provide various incentives to induce players to engage in continued or increased revenue-generating game play. For example, many gaming operators offer progressive jackpots as a player incentive. A progressive jackpot game is typically offered in parallel with a non-progressive game. Such jackpots are typically funded using portions of wagers placed in one or more non-progressive wagering games offered by one or more gaming machines. Thus, a progressive-eligible wager may have a chance of winning a winning outcome in the non-progressive wagering game as well as a separate chance of winning the progressive jackpot of the progressive jackpot game. A player typically has a lower chance of achieving a progressive jackpot than achieving a non-progressive winning outcome in a game offered by the gaming machine, but because progressive jackpots grow over time until they are won, progressive jackpots are also typically larger than most if not all individual non-progressive award amounts. Due to the fact that progressive jackpots are typically funded by player contributions from a large number of players, participating players may experience additional excitement due to the perception that they are competing “against” other players.

### SUMMARY

The systems, methods and devices of the disclosure each have several innovative aspects, no single one of which is solely responsible for the desirable attributes disclosed herein. One innovative aspect of the subject matter described in this disclosure can be implemented in a variety of ways.

In some implementations, a method of providing a multi-stake, multi-level jackpot may be provided. The method may include establishing a jackpot ladder with n jackpot levels. The method may further include establishing k groupings of jackpot levels within the n jackpot levels, where k may be greater than 2 and less than n, at least one of the k groupings of jackpot levels may include two or more of the n jackpot levels, each grouping of jackpot levels may be associated with a different wager size, and at least two of the k groupings of jackpot levels may be associated with sequentially adjacent wager sizes that have at least one jackpot level of the n jackpot levels in common. The method may further include providing a display indicating the n jackpot levels and indicia indicating, based on which jackpot levels are in each of the k groupings, the wager size or sizes associated with each jackpot level.

In some implementations of the method, the jackpot levels within each grouping may be contiguous.

In some implementations of the method, for each pair of adjacent groupings, the grouping in the pair of groupings associated with a higher wager size may include at least one jackpot level that is higher in average expected jackpot size than the jackpot levels in the grouping in the pair of groupings associated with a lower wager size and the grouping in the pair of groupings associated with the lower wager size may include at least one jackpot level that is lower in average expected jackpot size than the jackpot levels in the grouping in the pair of groupings associated with the higher wager size.

In some implementations of the method, at least one of the k groupings may include a different number of jackpot levels than the other groupings.

In some implementations of the method, each pair of sequentially adjacent wager sizes may have at least one jackpot level of the n jackpot levels in common.

In some implementations of the method, at least two of the k groupings of jackpot levels associated with sequentially adjacent wager sizes may have at least two jackpot levels of the n jackpot levels in common.

In some implementations of the method, at least one of the jackpot levels may be associated with three different groupings of the k groupings and, accordingly, three different wager sizes.

In some implementations of the method, wagers corresponding to any of the wager sizes associated, via the groupings, with a given jackpot level may have substantially equal odds of winning the given jackpot level.

In some implementations of the method, a wager of a given wager size may have a substantially equal chance of winning any of the jackpot levels in the grouping of jackpot levels associated with the given wager size.

In some implementations of the method, for groupings including an identical number of jackpot levels, the jackpot levels in corresponding relative positions in each of the groupings may have odds of winning that are the same and the odds of winning each jackpot level within any of the groupings are different between the jackpot levels.

In some implementations of the method, each jackpot level in each grouping may have odds that vary between groupings.

In some implementations of the method, the total return to player (RTP) for wagers placed at each wager size may not vary with wager size.

In some implementations of the method, the total return to player (RTP) for wagers placed at each wager size may increase with wager size.

In some implementations of the method, all of the groupings may have at least one jackpot level of the n jackpot levels in common.

In some implementations, a method of providing a multi-stake, multi-level jackpot is provided. The method may include establishing: a jackpot ladder with n jackpot levels, k different wager amounts, where k is greater than 2 and less than n, k groupings of jackpot levels, each grouping associated with a different one of the wager amounts, odds of winning each jackpot level in each grouping, a total jackpot return-to-player (RTP) associated with each grouping, and n seed values, each seed value associated with a different jackpot level. The method may further include determining, for each grouping, a seed RTP for each jackpot level in the grouping based on the seed value associated with that jackpot level and summing, for each grouping, the seed RTPs for each jackpot level in the grouping to produce a total seed RTP for the grouping. The method may further include determining, for each grouping, a total feed RTP by subtracting the total seed RTP, as well as any other non-feed RTPs associated with the jackpot levels in the grouping, from the total jackpot RTP for the grouping and determining, for each grouping, a total seed amount by summing the seed values associated with the jackpot levels within the grouping. The method may further include selecting an initial grouping of the k groupings and determining, for each jackpot level in the initial grouping, a feed RTP by multiplying the total feed RTP for the initial grouping by the seed value associated with the jackpot level and dividing by the total seed amount for the grouping. The method may further include, for each jackpot level in groupings other than the initial grouping, a) determining a feed RTP that has a previously-determined feed RTP associated with that jackpot level in a different grouping by multiplying that previously-determined feed RTP for that jackpot level by the wager size associated with the grouping for which the previously-determined feed RTP was determined and then dividing by the wager size associated with that jackpot level's grouping and b) selecting, for jackpot levels with feed RTPs not determinable via a), a feed RTP such that summing all of the feed RTPs associated with the jackpot levels within that jackpot level's grouping results in a summed amount that equals the total feed RTP for that jackpot level's grouping.

In some implementations of the method, the odds of winning each jackpot level in each grouping may be substantially the same within each grouping and between groupings.

In some implementations of the method, the seed RTP associated with each jackpot level may be apportioned between a “show now” amount and a “pre-growth” amount.

In some implementations of the method, the method may further include establishing an injection RTP for each wager size, wherein the total feed RTP for each grouping is determined by subtracting the total seed RTP, the injection RTP, as well as any other non-feed RTPs associated with the jackpot levels in the grouping, from the total jackpot RTP for the grouping.

In some implementations of the method, the method may further include determining a monetary contribution corresponding to each jackpot level in each grouping by multiplying the wager size associated with that grouping by the feed RTP for that jackpot level in that grouping, receiving indications of wagers placed in wagering games that are eligible to participate in the jackpot ladder based on the wagering game and the wager size of the wager, and contributing, for each wager received, an amount or amounts of that wager to meters for the jackpot levels in the grouping associated with the wager size of the wager, the amount or amounts contributed to each meter equal to the monetary contribution determined for the jackpot level for that meter in the grouping corresponding with the wager size.

In some implementations, a gaming system may be provided. The gaming system may include a logic system, the logic system including one or more processors and one or more memories communicatively connected with the one or more processors. The one or more memories may store computer-executable instructions for controlling the one or more processors to receive data establishing a jackpot ladder with n jackpot levels and establishing k groupings of jackpot levels within the n jackpot levels. The value k may be greater than 2 and less than n, at least one of the k groupings of jackpot levels may include two or more of the n jackpot levels, each grouping of jackpot levels may be associated with a different wager size, and at least two of the k groupings of jackpot levels associated with sequentially adjacent wager sizes may have at least one jackpot level of the n jackpot levels in common. The instructions may further include instructions for controlling the one or more processors to determine a feed return-to-player (RTP) percentage for each of the jackpot levels in each of the groupings based on the received data and provide, via a display device, a display indicating the n jackpot levels and indicia indicating, based on which jackpot levels are in each of the k groupings, the wager size or sizes associated with each jackpot level.

In some implementations of the gaming system, the jackpot levels within each grouping may be contiguous.

In some implementations of the gaming system, for each pair of adjacent groupings (when ranked by wager size), the grouping in the pair of groupings associated with a higher wager size may include at least one jackpot level that is higher in average expected jackpot size than the jackpot levels in the grouping in the pair of groupings associated with a lower wager size, and the grouping in the pair of groupings associated with the lower wager size may include at least one jackpot level that is lower in average expected jackpot size than the jackpot levels in the grouping in the pair of groupings associated with the higher wager size.

In some implementations of the gaming system, at least one of the k groupings may include only one of the n jackpot levels.

In some implementations of the gaming system, each pair of sequentially adjacent wager sizes may have at least one jackpot level of the n jackpot levels in common.

In some implementations of the gaming system, at least two of the k groupings of jackpot levels associated with sequentially adjacent wager sizes may have at least two jackpot levels of the n jackpot levels in common.

In some implementations of the gaming system, at least one of the jackpot levels may be associated with three different groupings of the k groupings and, accordingly, three different wager sizes.

In some implementations of the gaming system, wagers corresponding to any of the wager sizes associated, via the groupings, with a given jackpot level may have substantially equally equal odds of winning the given jackpot level.

In some implementations of the gaming system, a wager of a given wager size may have a substantially equal chance of winning any of the jackpot levels in the grouping of jackpot levels associated with the given wager size.

In some implementations of the gaming system, the total return to player (RTP) for wagers placed at each wager size does not vary with wager size.

In some implementations, a gaming system is provided. The gaming system may include a logic system. The logic system may include one or more processors and one or more memories communicatively connected with the one or more processors. The one or more memories may store computer-executable instructions for controlling the one or more processors to receive data establishing: a jackpot ladder with n jackpot levels, k different wager amounts, where k is greater than 2 and less than n, k groupings of jackpot levels, each grouping associated with a different one of the wager amounts, odds of winning each jackpot level in each grouping, a total jackpot return-to-player (RTP) percentage associated with each grouping, and n seed values, each seed value associated with a different jackpot level. The computer-executable instructions may further include instructions for controlling the one or more processors to determine, for each grouping, a seed RTP for each jackpot level in the grouping based on the seed value associated with that jackpot level and to sum, for each grouping, the seed RTPs for each jackpot level in the grouping to produce a total seed RTP for the grouping. The computer-executable instructions may also include instructions for controlling the one or more processors to determine, for each grouping, a total feed RTP by subtracting the total seed RTP, as well as any other non-feed RTPs associated with the jackpot levels in the grouping, from the total jackpot RTP for the grouping and determine, for each grouping, a total seed amount by summing the seed values associated with the jackpot levels within the grouping. The computer-executable instructions may further include instructions for controlling the one or more processors to receive data indicating an initial grouping of the k groupings and determine, for each jackpot level in the initial grouping, a feed RTP by multiplying the total feed RTP by the seed value associated with the jackpot level and dividing by the total seed amount for the grouping. The computer-executable instructions may further include instructions for controlling the one or more processors to, for each jackpot level in groupings other than the initial grouping, a) determine a feed RTP that has a previously-determined feed RTP associated with that jackpot level in a different grouping by multiplying that previously-determined feed RTP for that jackpot level by the wager size associated with the grouping for which the previously-determined feed RTP was determined and then dividing by the wager size associated with that jackpot level's grouping and b) select, for jackpot levels with feed RTPs not determinable via a), a feed RTP such that summing all of the feed RTPs associated with the jackpot levels within that jackpot level's grouping results in a summed amount that equals the total feed RTP for that jackpot level's grouping.

In some implementations of the gaming system, the odds of winning each jackpot level in each grouping may be substantially the same within each grouping and between groupings.

In some implementations of the gaming system, the seed RTP associated with each jackpot level may be apportioned between a “show now” amount and a “pre-growth” amount.

In some implementations of the gaming system, the one or more memories may further store computer-executable instructions for controlling the one or more processors to receive data establishing an injection RTP for each wager size. The computer-executable instructions for determining the total feed RTP for each grouping may also include instructions to determine the total feed RTP by subtracting the total seed RTP, the injection RTP, as well as any other non-feed RTPs associated with the jackpot levels in the grouping, from the total jackpot RTP for the grouping.

In some implementations of the gaming system, the one or more memories may further store computer-executable instructions for controlling the one or more processors to determine a monetary contribution corresponding to each jackpot level in each grouping by multiplying the wager size associated with that grouping by the feed RTP for that jackpot level in that grouping, receive indications of wagers placed in wagering games that are eligible to participate in the jackpot ladder based on the wagering game and the wager size of the wager, and cause, for each wager received, an amount or amounts of that wager to be contributed to meters for the jackpot levels in the grouping associated with the wager size of the wager, the amount or amounts contributed to each meter equal to the monetary contribution determined for the jackpot level for that meter in the grouping corresponding with the wager size.

In some implementations, a non-transitory, machine-readable medium may be provided. The machine-readable medium may store instructions for controlling one or more processors to receive data establishing a jackpot ladder with n jackpot levels and establishing k groupings of jackpot levels within the n jackpot levels. The value of k may be greater than 2 and less than n, at least one of the k groupings of jackpot levels may include two or more of the n jackpot levels, each grouping of jackpot levels may be associated with a different wager size, and at least two of the k groupings of jackpot levels associated with sequentially adjacent wager sizes may have at least one jackpot level of the n jackpot levels in common. The machine-readable medium may further store instructions for controlling the one or more processors to determine a feed return-to-player (RTP) percentage for each of the jackpot levels in each of the groupings based on the received data and to cause a display device to indicate the n jackpot levels and indicia indicating, based on which jackpot levels are in each of the k groupings, the wager size or sizes associated with each jackpot level.

In some implementations of the machine-readable medium, the jackpot levels within each grouping may be contiguous.

In some implementations of the machine-readable medium, for each pair of adjacent groupings, the grouping in the pair of groupings associated with a higher wager size may include at least one jackpot level that is higher in average expected jackpot size than the jackpot levels in the grouping in the pair of groupings associated with a lower wager size, and the grouping in the pair of groupings associated with the lower wager size may include at least one jackpot level that is lower in average expected jackpot size than the jackpot levels in the grouping in the pair of groupings associated with the higher wager size.

In some implementations of the machine-readable medium, at least one of the k groupings may include only one of the n jackpot levels.

In some implementations of the machine-readable medium, each pair of sequentially adjacent wager sizes may have at least one jackpot level of the n jackpot levels in common.

In some implementations of the machine-readable medium, at least two of the k groupings of jackpot levels associated with sequentially adjacent wager sizes may have at least two jackpot levels of the n jackpot levels in common.

In some implementations of the machine-readable medium, at least one of the jackpot levels may be associated with three different groupings of the k groupings and, accordingly, three different wager sizes.

In some implementations of the machine-readable medium, wagers corresponding to any of the wager sizes associated, via the groupings, with a given jackpot level may have substantially equally equal odds of winning the given jackpot level.

In some implementations of the machine-readable medium, a wager of a given wager size may have a substantially equal chance of winning any of the jackpot levels in the grouping of jackpot levels associated with the given wager size.

In some implementations of the machine-readable medium, the total RTP for wagers placed at each wager size may not vary with wager size.

In some implementations, a non-transitory, machine-readable medium may be provided. The machine-readable medium may store instructions for controlling one or more processors to receive data establishing: a jackpot ladder with n jackpot levels, k different wager amounts, where k is greater than 2 and less than n, k groupings of jackpot levels, each grouping associated with a different one of the wager amounts, odds of winning each jackpot level in each grouping, a total jackpot return-to-player percentage (RTP) associated with each grouping, and n seed values, each seed value associated with a different jackpot level. The machine-readable medium may further store instructions for controlling the one or more processors to determine, for each grouping, a seed RTP for each jackpot level in the grouping based on the seed value associated with that jackpot level and sum, for each grouping, the seed RTPs for each jackpot level in the grouping to produce a total seed RTP for the grouping. The machine-readable medium may also store instructions for controlling the one or more processors to determine, for each grouping, a total feed RTP by subtracting the total seed RTP, as well as any other non-feed RTPs associated with the jackpot levels in the grouping, from the total jackpot RTP for the grouping and determine, for each grouping, a total seed amount by summing the seed values associated with the jackpot levels within the grouping. The machine-readable medium may further store instructions for controlling the one or more processors to receive data indicating an initial grouping of the k groupings and determine, for each jackpot level in the initial grouping, a feed RTP by multiplying the total feed RTP by the seed value associated with the jackpot level and dividing by the total seed amount for the grouping. The machine-readable medium may additionally store instructions for controlling the one or more processors to, for each jackpot level in groupings other than the initial grouping, a) determine a feed RTP that has a previously-determined feed RTP associated with that jackpot level in a different grouping by multiplying that previously-determined feed RTP for that jackpot level by the wager size associated with the grouping for which the previously-determined feed RTP was determined and then dividing by the wager size associated with that jackpot level's grouping and b) select, for jackpot levels with feed RTPs not determinable via a), a feed RTP such that summing all of the feed RTPs associated with the jackpot levels within that jackpot level's grouping results in a summed amount that equals the total feed RTP for that jackpot level's grouping.

In some implementations of the machine-readable medium, the odds of winning each jackpot level in each grouping may be substantially the same within each grouping and between groupings.

In some implementations of the machine-readable medium, the seed RTP associated with each jackpot level may be apportioned between a “show now” amount and a “pre-growth” amount.

In some implementations of the machine-readable medium, the machine-readable medium may further store instructions for controlling the one or more processors to receive data establishing an injection RTP for each wager size. The total feed RTP for each grouping may be determined by subtracting the total seed RTP, the injection RTP, as well as any other non-feed RTPs associated with the jackpot levels in the grouping, from the total jackpot RTP for the grouping.

In some implementations of the machine-readable medium, the machine-readable medium may further store instructions for controlling the one or more processors to determine a monetary contribution corresponding to each jackpot level in each grouping by multiplying the wager size associated with that grouping by the feed RTP for that jackpot level in that grouping, receive indications of wagers placed in wagering games that are eligible to participate in the jackpot ladder based on the wagering game and the wager size of the wager, and cause, for each wager received, an amount or amounts of that wager to be contributed to meters for the jackpot levels in the grouping associated with the wager size of the wager, the amount or amounts contributed to each meter equal to the monetary contribution determined for the jackpot level for that meter in the grouping corresponding with the wager size.

### BRIEF DESCRIPTION OF THE DRAWINGS

The included drawings are for illustrative purposes and serve only to provide examples of possible structures and process steps for the disclosed inventive systems, methods, and apparatuses for providing multi-stake, multi-level progressive jackpot ladders with overlapping eligibility bands for wagering game play. These drawings in no way limit any changes in form and detail that may be made to implementations by one skilled in the art without departing from the spirit and scope of the disclosure.

FIG. 1 depicts an example of a 9-level jackpot ladder with 6 wager sizes.

FIG. 2 depicts the 9-level jackpot ladder of FIG. 1 with seed value amounts for each jackpot level shown.

FIG. 3 depicts the 9-level jackpot ladder of FIG. 1 with seed RTPs for each jackpot level in each grouping shown.

FIG. 4 depicts the 9-level jackpot ladder of FIG. 1 with total feed RTPs for each grouping shown.

FIG. 5 depicts the 9-level jackpot ladder of FIG. 1 and feed RTPs for each jackpot level in an initial grouping associated with one of the wager sizes.

FIG. 6 depicts the 9-level jackpot ladder of FIG. 1 and some feed RTPs for jackpot level groupings adjoining the initial grouping.

FIG. 7 depicts the 9-level jackpot ladder of FIG. 6 as well as the remaining feed RTPs for the jackpot level groupings adjoining the initial grouping.

FIG. 8 depicts the 9-level jackpot ladder of FIG. 7 and some feed RTPs for further jackpot level groupings adjoining the groupings adjoining the initial grouping.

FIG. 9 depicts the 9-level jackpot ladder of FIG. 8 as well as the remaining feed RTPs for the further jackpot level groupings adjoining the groupings adjoining the initial grouping.

FIG. 10 depicts the 9-level jackpot ladder of FIG. 8 and some feed RTPs for the lowest wager size jackpot level grouping.

FIG. 11 depicts the 9-level jackpot ladder of FIG. 10 as well as the remaining feed RTP for the lowest wager size jackpot level grouping.

FIG. 12 depicts the 9-level jackpot ladder of FIG. 10 as well as RTP values from feed, seed, and injection.

FIG. 13 depicts a flow diagram of one example technique for implementing a multi-level, multi-stake progressive jackpot with overlapping eligibility bands.

FIG. 14 depicts the 9-level jackpot ladder of FIG. 12 as well as monetary contribution values for each jackpot level in each grouping.

FIGS. 15A and 15B depict two example jackpot ladder structures.

FIGS. 16A-16C depict isometric, front, and side views, respectively, of a wagering game machine which may be used in implementing the techniques described herein.

FIG. 17 depicts a high-level conceptual schematic of a wager gaming system which may be used to implement the techniques described herein.

### DETAILED DESCRIPTION

Although the following text sets forth a detailed description of numerous different embodiments, it should be understood that the legal scope of the invention is defined by the words of the claims set forth at the end of this patent. The detailed description is to be construed as an example only and does not describe every possible embodiment since describing every possible embodiment would be impractical, if not impossible. Numerous alternative embodiments may be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

In the context of a gambling proposition and this disclosure, return-to-player (RTP) represents the long-term average expected payback that players, as a whole, are expected to receive over a very large number of games, said payback being the ratio of game awards paid relative to total wagers placed. Similarly, the RTP for the progressive jackpot portion of a game, referred to as jackpot RTP, may be calculated by dividing the average progressive jackpot amount by the product of the wager amount multiplied by the odds of winning the jackpot. For example, for a progressive game with a $100 jackpot, odds of 1 in 1000 of winning, and a $2 wager size, the RTP would be $100/($2*1000)=0.05 or 5.00%. In a scenario where the progressive jackpot is funded entirely from contributions from the players' wagers, the contribution from each wager may be calculated by multiplying the wager size by the RTP, e.g., $2*0.05=$0.10. Progressive jackpot funding that is derived from contributions from players' wagers is referred to as “feed.”

While the RTP in the above example is calculated based on a known average jackpot amount, it is common practice in the industry to select a desired total jackpot RTP and then drive the calculation, for example, of the average jackpot amount, the odds, or the wager size based on that desired total jackpot RTP. For example, a gaming operator or manufacturer may select a progressive total jackpot RTP of 0.125 to be in accordance with local gaming regulations. If the gaming operator or manufacturer wishes to operate a progressive jackpot with odds of 1 in 1000 and a $2 wager size with a 0.125 RTP, this would result in an average jackpot size of $250.

RTP may frequently be expressed as a percentage rather than a pure decimal ratio, in which case the RTP of 0.125 for this example would be expressed as an RTP of 12.5%. Within the industry, either convention may be used, and it is to be understood that both conventions may be used interchangeably provided the appropriate conversion is performed, e.g., dividing the percentage by 100 to provide the decimal equivalent, or multiplying the decimal equivalent by 100 to provide the percentage.

The RTP for a given jackpot uses said jackpot's average value which may include award amounts other than just the “feed.” In progressive jackpot systems, for example, it is common to “seed” the jackpot meter for a given progressive jackpot with a starting amount of funding. The seed amount or value may be used to prime the jackpot meter after a jackpot win to avoid the situation where the jackpot meter value is so low, e.g., zero, that players may not be interested in participating in the progressive game. The seed value is often chosen by the gaming operator or manufacturer based on market data/trends regarding what seed values are viewed by players as appropriate for a given bet size. If a player wins the jackpot, they are awarded the seed value, plus any accumulated funds contributed from player wagers during the jackpot cycle.

Another factor that may affect RTP for a given jackpot is whether or not there is any “injection” into the jackpot meter. Gaming operators and manufacturers may “inject” funds into the jackpot meter over time to give players observing the meters the impression that the meter is always growing. For example, during peak play hours, the jackpot meter may exhibit rapid growth since many players may be playing. However, during non-peak play hours, the jackpot meter may exhibit lethargic growth since fewer players are playing. This may discourage players from continuing to play or discourage potential players from starting to play. To mitigate this effect, the gaming operator or manufacturer may allocate an “injection” pool of funds that are added to the jackpot meter independent of any particular wager contribution. Such injection may be performed at a constant rate, or may be varied depending on the time of day or other factors, e.g., during periods of high player activity, injection may be slowed or stopped, and during periods of low player activity, injection may be increased). Injection may also be specified in the form of an injection RTP, e.g., 1%. In such cases, the average funding due to injection from jackpot to jackpot may be calculated by multiplying the injection RTP by the associated wager amount times the odds of winning For example, for 1% injection RTP for a wager size of $2 for a jackpot with odds of 1 in 1000 of winning, the average injection funding would be 1%*$2*1000=$20. The corresponding inject rate for a constant injection-rate system, for example, may be calculated as average injection funding per jackpot/average time between jackpots. For example, if a given jackpot is won, on average, six times a day, then the average time between jackpots=24 hours/day/6 jackpots/day=4 hours/jackpot, thus the injection rate, continuing with the current example, would be $20/4 hour=$5/hour=500 cents/3600 seconds=1 cent/7.2 seconds. It should be understood that, in effect, injection and feed may both be funded by portions of each wager placed. Feed is a hard contribution that is reserved for placement into the jackpot (most gaming regulations set a minimum RTTP, and the feed RTP may be calibrated off of that value). Injection, however, is discretionary—gaming operators and manufacturers may use feed as a flexible mechanism to encourage continued player play, e.g., by sweetening the pot, giving the appearance of player activity, etc. These actions, however, are discretionary. Thus, injection RTP and feed RTP are typically kept segregated, although the technique disclosed herein could also be performed in situations where such is not the case.

In the case of both seed and injection funding, funds that have been allocated for either purpose but that have not yet been added to the jackpot meter as of the time that the jackpot is won may be awarded to the winner as well or may be reserved for funding future jackpots or, in some cases, retained by the gaming operator or manufacturer. It is to be understood that the RTP values discussed herein refer to expected average RTP values, e.g., values calculated based on the theoretical odds of winning the average sized progressive jackpot.

Each of these sources of funding, i.e., feed, seed, and injection, as well as any other sources of jackpot funding, may, if present, contribute to the calculation of the overall RTP for the progressive jackpot. For example, the overall or total jackpot RTP may be viewed as the sum of the RTPs associated with the feed funding mechanism, the seed funding mechanism, and the injection funding mechanism.

For example, consider a progressive game with a $50 seed value, $20 of injection funding, a $2 wager size, and odds of winning of 1 in 1000. The “seed” RTP for such a progressive game would be $50/($2*1000)=2.5%, and the “injection” RTP for such a progressive game would be $20/($2*1000)=1%. Finally, assume that the average jackpot award in such a game is $250. If one subtracts out the portions of the average jackpot award that are funded from non-feed sources, e.g., the $50 of seed funding and the $20 of injection funding, the amount of the average jackpot award that comes from feed contributions is $180. The “feed” RTP is thus $180/($2*1000)=9%. The overall or total jackpot RTP in such an example is 2.5%+1%+9%=12.5%.

In many cases, gaming operators or manufacturers may prefer to specify a particular jackpot structure at least partially in terms of RTPs. For example, a gaming operator or manufacturer may, for a particular progressive, wish to specify a seed amount, a total jackpot RTP, and an injection RTP for a given progressive. In such situations, the feed RTP needed to support such a progressive jackpot structure may be calculated based on the other values provided. For example, consider a progressive jackpot based on a wagering game featuring $2 wagers and 1 in 1000 odds where the progressive jackpot has a desired total jackpot RTP of 11.5% and is funded using a seed value of $40 and injection RTP of 1.25%. In such a progressive jackpot, the seed RTP is 2%, the injection RTP is 1.25%, and the desired total jackpot RTP is 11.5%. Accordingly, the feed RTP needed to support such a desired total jackpot RTP would be calculated by subtracting the non-feed RTP values from the desired total jackpot RTP value, i.e., 11.5%−2%−1.25%=8.25%. Accordingly, the amount of each $2 wager that would need to be contributed to such a jackpot would be 8.25%*$2=$0.165. The average jackpot amount of such a progressive jackpot would be $40 (seed)+$25 (injection, i.e., 1.25%*$2*1000=$25)+$165 (feed, i.e., 8.25%*$2*1000)=$230, which corresponds to the desired total jackpot RTP of 11.5%.

It is to be understood that the actual RTP that one or more given players experience can, and will, vary greatly from the RTPs and RTPs discussed above, relative to how many games those players play. The actual RTP for one or more players is the ratio of the players' actual amount won to the players' actual amount wagered over a given period of time. The larger the number of games the one or more given players play, the more likely that the actual RTP will trend towards the RTP. In the context of a progressive jackpot gambling proposition, the RTP is based on the effect of a very large number of jackpots awarded over a very large number of games, thus reflecting the expected payback of the average jackpot award.

In the context of this disclosure, the progressive seed, or simply “seed,” is an amount of money which is used to fund a progressive jackpot but which does not result in a chance to win that progressive jackpot. Seed money, for example, is often contributed by the gaming operator offering the progressive jackpot.

A meter, or meter amount, in the context of the present disclosure, refers to an accumulator which records the value of a progressive jackpot over time. It may also be used to refer to a device or graphic which reports out the current value of the progressive jackpot over time, i.e., the value in the accumulator.

Various examples involving numerical calculation are given throughout this paper. In many cases, the results of such calculations are shown rounded to the nearest thousandth. However, in practice, such calculations may be performed to a much higher degree of precision, and rounding may not be used, may be minimized to the extent possible, or may be replaced with some other technique, such as flooring to the nearest payable currency unit, such as $0.01 or 1 cent.

All of the following methods and processes, along with other methods and processes of the present invention, may be implemented by software, firmware and/or hardware. For example, the methods of the present invention may be implemented by computer programs embodied in machine-readable media. The invention may be implemented by networked gaming machines, game servers and/or other such devices. Those of skill in the art will appreciate that the steps of the methods described herein are not necessarily performed (and in some implementations are not performed) in the order shown. Moreover, some implementations of the methods described herein may include more or fewer steps than those shown and/or described.

In practical terms, some example server-based or distributed logic systems, as described herein, may be used to provide a multi-stake, multi-level jackpot (sometimes referred to a “jackpot ladder”). In such a jackpot game, there may be a number of different jackpot levels (sometimes referred to simply as jackpots) that may be won by a player that is playing a base game that is participating in the progressive jackpot game. The base game may support a number of different wager sizes. Each wager size may be associated with a different group of jackpot levels.

To begin with, the basic overall structure of a multi-stake, multi-level progressive jackpot with overlapping eligibility bands may be defined by a gaming operator or manufacturer. Such definition may, for example, involve establishing overall parameters such as how many jackpot levels are to exist in the game, what the odds are to be of winning each jackpot, what wager sizes will be eligible to win jackpots/participate in the progressive jackpot, etc. Some of these parameters may be driven by marketing or player demographic data (for example, wager sizes may be selected to correspond with wager sizes that are known to be common wager sizes that players are comfortable with), whereas other parameters may be driven by other factors.

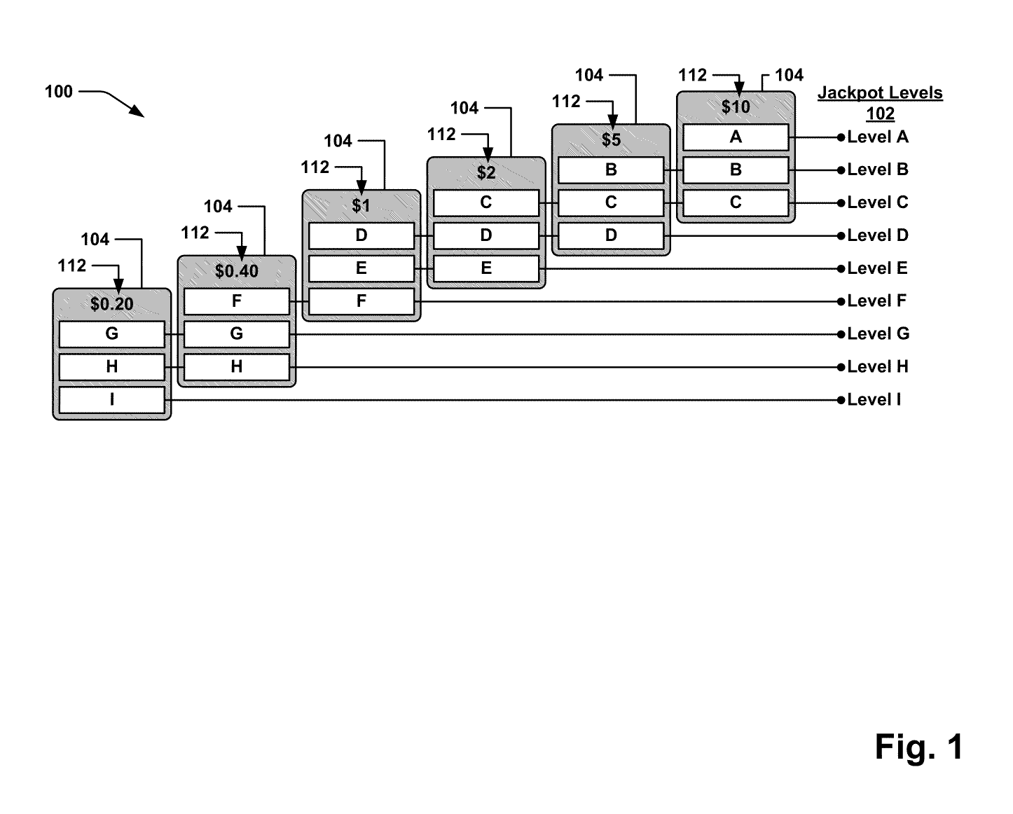

FIG. 1 depicts an example of a 9-level jackpot ladder with 6 wager sizes. Other numbers of jackpot levels could be used, e.g., 5, 8, 12, 17, etc., as well as other numbers of wager sizes, e.g., 2, 4, 5, 9, etc. wager sizes. The selection of these values may be driven, for example, by the impression that the provider of the jackpot ladder may wish to convey—large numbers of jackpot levels and/or wager sizes may give the impression that there are many play options for players, but may also intimidate players or may result in insufficient differentiation between the different jackpot levels and/or wager sizes. FIG. 1 is to be understood to be figurative in nature—a jackpot ladder such as the one shown may be expressed in any number of different forms, including tabular, list, array, or other data formats. It is to be understood that, at various points in this disclosure, the terms “adjacent” or “contiguous” or other spatially-relative terminology may be used with respect to wager sizes or jackpot levels. In such contexts, such terms generally refer to the arrangement of wager sizes and jackpot levels in order of size, e.g., lowest wager size or jackpot level to highest wager size or jackpot level.

In FIG. 1, nine jackpot levels 102 are shown in jackpot ladder 100, each identified by a different letter A-I (with A corresponding to the highest jackpot award amount, and I corresponding to the lowest). Six different wager sizes 104 are also indicated: $0.20, $0.40, $1.00, $2.00, $5.00, and $10.00. Each wager size shown is associated with, and eligible for, a grouping 104 of several jackpot levels. For example, the $0.20 wager size is associated with, and eligible for, the G, H, and I jackpot levels. The $0.40 wager size is associated with, and eligible for, the F, G, and H jackpot levels. The $1.00 wager size is associated with, and eligible for, the D, E, and F jackpot levels. The $2.00 wager size is associated with, and eligible for, the C, D, and E jackpot levels. Finally, the $5.00 wager size is associated with, and eligible for, the B, C, and D jackpot levels, and the $10.00 wager size is associated with, and eligible for, the A, B, and C jackpot levels. As can be seen in this example, each wager size grouping 104 of jackpot levels 102 shares at least one jackpot level 102 in common with any adjacent wager size groupings 104 (when ordered by wager size 112 amount). Furthermore, in this example, for each pair of adjacent wager size groupings 104, the grouping 104 associated with the higher-value wager size 112 may include one or more jackpot levels 102 that are higher than any jackpot levels 102 included in the grouping 104 associated with the lower-value wager size 112, and the grouping 104 associated with the lower-value wager size 112 may include one or more jackpot levels 102 that are lower than any jackpot levels 102 included in the grouping 104 associated with the higher-value wager size 112.

It is to be understood a wager placed at a particular wager size 112 will be eligible, in such an implementation, to win any of the jackpot levels 102 within the grouping 104 for that wager size 112. Thus, for example, a wager of $5 would, in this scenario, be eligible to win the B, C, or D jackpot level 102. However, it is to be understood that a $2 or a $10 wager would also be eligible to win the C jackpot level 102 (such wagers would also be eligible to win other jackpot levels 102 in their respective associated groupings 104 as well). It is also to be understood that, while this example shows groupings 104 that each include three jackpot levels 102, other implementations may feature groupings 104 with different numbers of jackpot levels 102, e.g., one grouping 104 may have, for example, 2 jackpot levels 102, and another grouping 104 in the same jackpot ladder 100 may have 3 or 4 jackpot levels 102. The number of jackpot levels 102 in each grouping 104, however, may be at least somewhat driven by the overall number of jackpot levels 102 and the number of groupings 104.

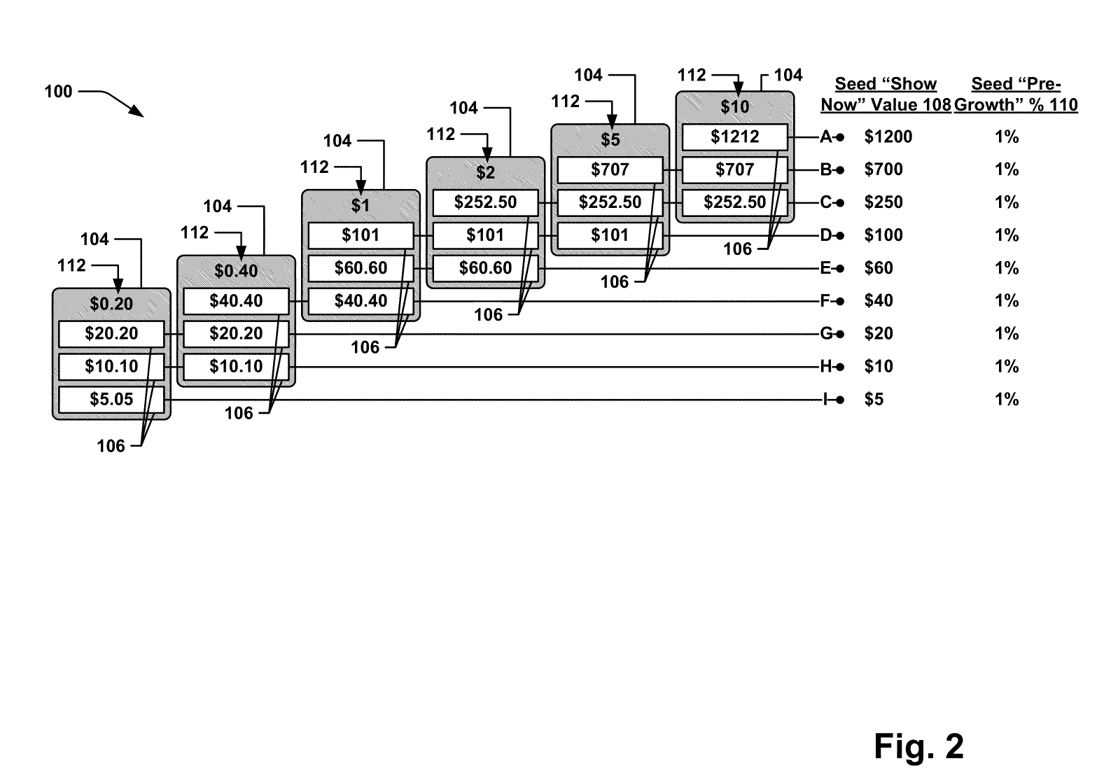

FIG. 2 depicts the 9-level jackpot ladder of FIG. 1 with seed value amounts for each jackpot level shown. In FIG. 2, the jackpot ladder 100 has been augmented to show seed values 106 for each jackpot level 102. As shown in FIG. 2, seed values 106 may be assigned to each jackpot level 102. Such seed values may, in some implementations, be broken up into a “show now” portion 108 and a “pre-growth” portion 110. The “show now” portion 108 for each seed value 106 may be a number less than the seed value 106 that is also unlikely to cause player concern. Such numbers may be selected based on market data indicating what “show now” portions 108 players expect. In other implementations, such seed values 106 selection may follow a rough rule of thumb, e.g., the seed value 106 for each jackpot level 102 may be approximately twice the amount of the seed value 106 for the next lowest jackpot level 102. The “show now” portion 108 may, for example, be a value that is an even multiple of five, ten, or one hundred, as such values appear to be convenient, round numbers that are easy for players to digest and remember.

The “pre-growth” portion 110 of each seed value 106 may be designated as an amount, or as a percentage (as shown). The “pre-growth” portion 110 may be added to the meter displaying the “show now” portion 108 during a period of time just after the meter is initialized. Players that witness a jackpot meter or meters initialize with the “show now” portion 108 for the associated jackpot level(s) 102 may then start to see that meter or those meters increase with amounts drawn from the respective “pre-growth” portions 110. In this particular example, the “pre-growth” portions 110 are set at 1% of the “show now” portions 108. Thus, for example, the seed value 106 for the A jackpot level 102 is $1200 (“show now” portion 108)+1%*$1200 (“pre-growth” portion 110)=$1212. For the B jackpot level 102, the seed value 106 is $707, which is indicated in both groupings 104 that include the B jackpot level. It is to be understood that while the seed value 106 of $707 appears in two different groupings 104, there is only one pool of funds of $707 that is shared between those two groupings 104. A similar observation may be made with respect to the three indications of $252.50 shown in the three groupings 104 associated with the $2, $5, and $10 wager sizes 112—there is only one pool of funds of $252.50 that is shared between those three groupings 104.

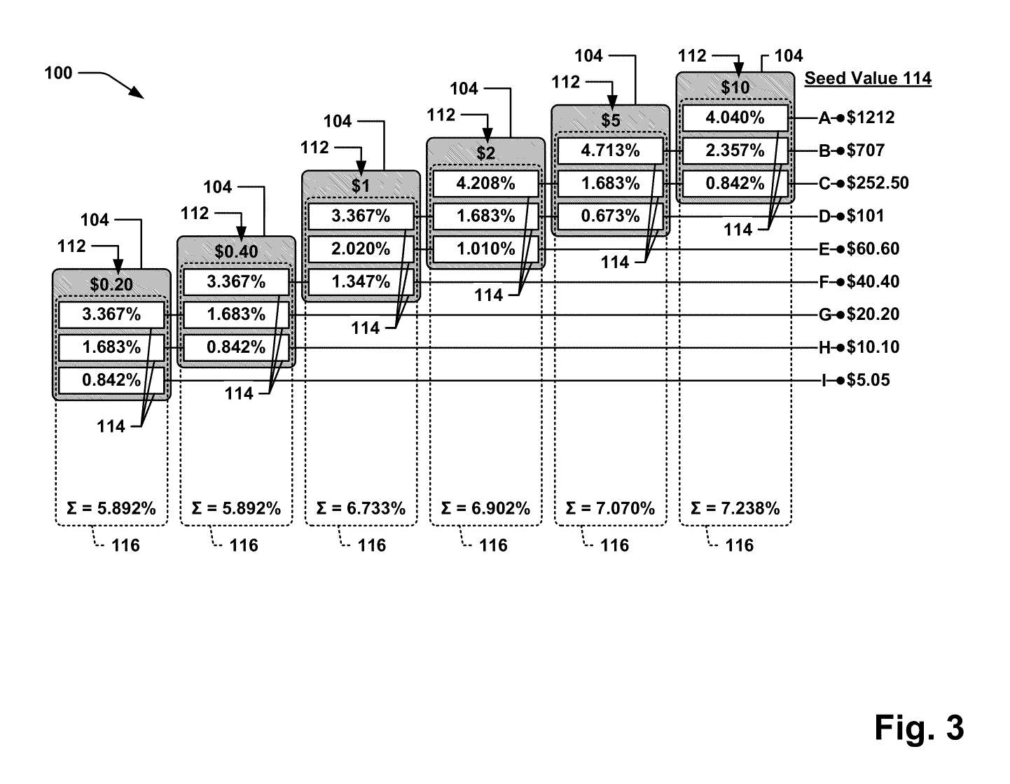

FIG. 3 depicts the 9-level jackpot ladder of FIG. 1 with seed RTPs for each jackpot level in each grouping shown. As can be seen, seed RTPs 114 are shown for each jackpot level 102 in each grouping 104. The seed RTP 114 for each jackpot level 102 in each grouping 104 may be calculated by dividing the seed value 106 for that jackpot level 102 and grouping 104 by the product of the wager size 112 for that grouping 104 multiplied by the odds for that jackpot level. In this example, the odds for each jackpot level 102 have been set to be 3000 to 1. Thus, for the $10 wager size 112, the seed RTP 114 for the A jackpot level 102 in the grouping 104 associated with the $10 wager size 112 may be calculated by dividing the corresponding seed value 106, which is $1212, by the product of multiplying the $10 wager size 112 by the odds of 3000, i.e., $1212/($10*3000)=4.04%. Similarly, the seed RTP 114 for the B jackpot level 102 in the grouping 104 associated with the $10 wager size 112 may be calculated by dividing the corresponding seed value 106, which is $707, by the product of multiplying the $10 wager size 112 by the odds of 3000, i.e., $707/($10*3000)=2.357%. For the jackpot level C 102 in the grouping 104 associated with the $10 wager size 112, the seed RTP 114 may be calculated by dividing the corresponding seed value 106 of $252.50 by the product of multiplying the $10 wager size 112 by the odds of 3000, i.e., $252.50/($10*3000)=0.842%. This process may be repeated for each of the other groupings 104 as well. For example, for the grouping 104 associated with the $5 wager size 112, the seed RTP 114 for the B jackpot level 102 may be calculated by dividing the corresponding seed value 106 of $707 by the product of multiplying the $5 wager size 112 by the odds of 3000, i.e., $707/($5*3000)=4.713%. Once such calculations have been completed for each jackpot level 102 in each grouping 104, a total seed RTP 116 for each grouping 104 may be calculated by summing the seed RTPs 114 for the jackpot levels 102 within that grouping 104. For example, with respect to the grouping 104 associated with the $10 wager size 112, the total seed RTP 116 may be calculated by adding 4.04%+2.357%+0.842%=7.238%. This may be repeated for each grouping 104.

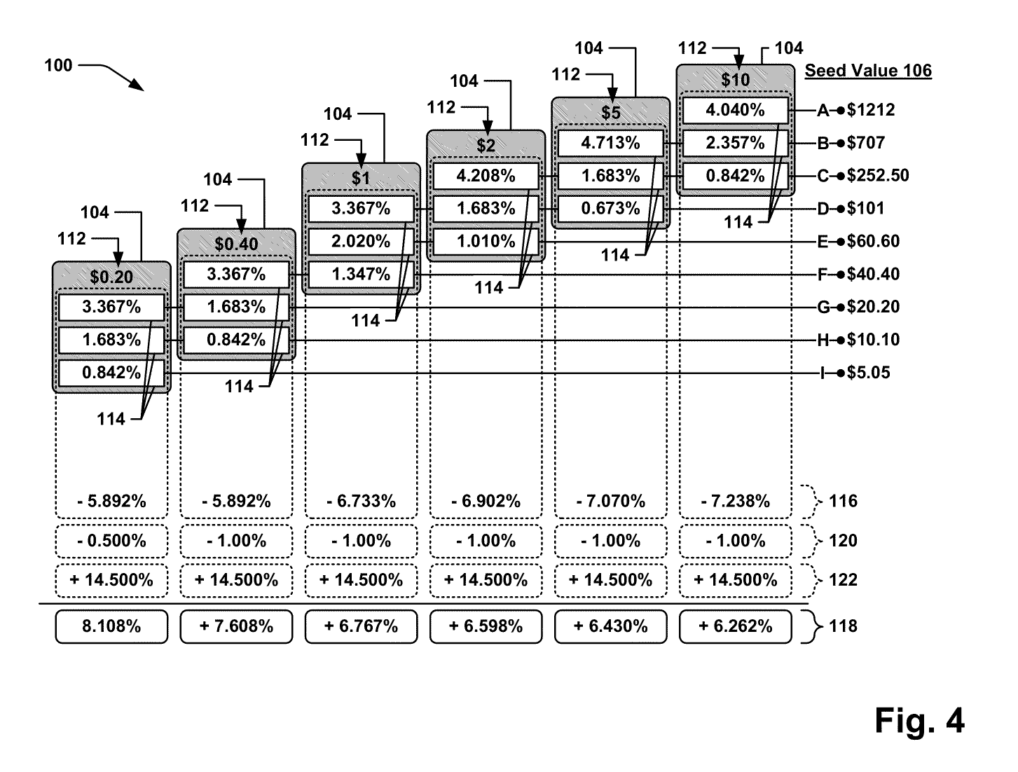

After the total seed RTPs 116 have been determined for each grouping 104, total feed RTPs 118 may be calculated for each grouping 104. The total feed RTP 118 for each grouping 104 may be calculated by subtracting the total seed RTP 116 for that grouping 104, as well as any other non-feed RTPs for that grouping 104, from the total jackpot RTP 122 for that grouping 104. In a more general sense, whatever RTPs are not attributable to funding mechanisms that have a chance to win the jackpot may be subtracted from the total jackpot RTP 122 to derive the total feed RTP 118. This is demonstrated in FIG. 4. For example, in FIG. 4, the total jackpot RTP 122 for each of the groupings 104 is 14.5%. For each grouping 104, the corresponding total seed RTP 116 and total injection RTP 120 for that grouping 104, may be subtracted from the total jackpot RTP 122 of 14.5%. Thus, for example, the total feed RTP 118 for the $10 wager size 112 grouping 104 may be calculated by subtracting the 1% of total injection RTP 120 and the 7.238% of total seed RTP 116 from the total jackpot RTP 122 of 14.5%, i.e., 14.5%−1%−7.238%=6.262%. Such calculations may be repeated for each of the groupings 104 to produce a total feed RTP 118 specific to each grouping 104. It is to be noted that, in this example, the total jackpot RTPs 122 are all the same, although this technique may also be used with non-identical total jackpot RTPs 122 across the groupings 104. Additionally, the total injection RTPs 120 for each grouping 104 may be the same or may be varied depending on the desires of the gaming operator or manufacturer that is configuring the jackpot ladder 100. In this example, the total injection RTPs 120 for each grouping are all set to 1% except for the total injection RTP 120 for the grouping 104 associated with the $0.20 wager size 112, which is set to 0.5% instead. Generally speaking, the total injection RTP 120 for each grouping may be set to any value between 0% and a value that does not exceed the total jackpot RTP 122 for that grouping 104 when summed with the total seed RTP 116 for that grouping. A 0% total injection RTP 120 is effectively the same as no injection at all, which is also a way to implement aspects of the jackpot ladder 100. It is to be understood that such a jackpot ladder could also be implemented with no seed mechanism as well, effectively resulting in a 0% total seed RTP 116 for each grouping. While this would be a relatively unexciting progressive jackpot game for players, such progressive jackpot implementations are possible.

After the total feed RTPs 118 for each grouping 104 have been determined, individual feed RTPs 124 for each jackpot level 102 in each grouping 104 may be determined. The individual feed RTP 124 for a given jackpot level 102 in a grouping 104 may be used to determine the amount of each wager of the wager size 112 associated with that grouping 104 that is contributed to that jackpot level 102.

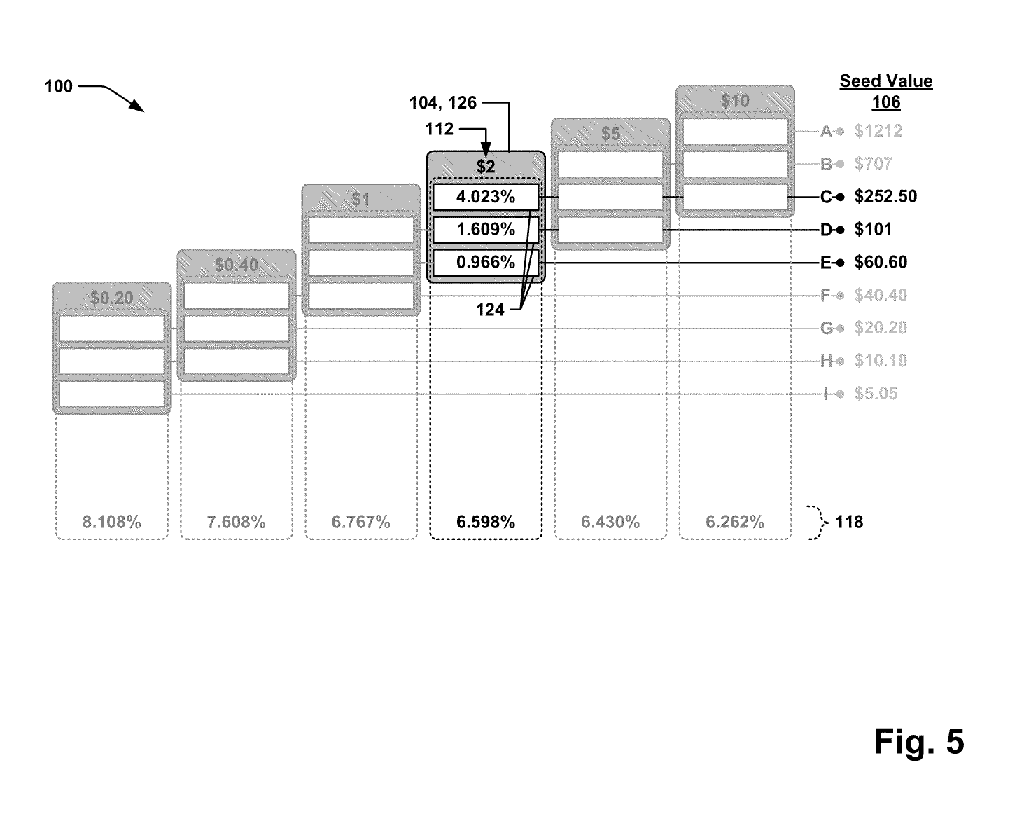

Initially, the feed RTPs 124 for each jackpot level 102 in a single, selected initial grouping 126 of the groupings 104 may be determined, followed by determinations of the feed RTPs 124 for each jackpot level 102 in the remaining groupings 104. The selection of the initial grouping 126 may be arbitrary, i.e., the initial grouping 126 may any one of the groupings 104, in some implementations. For example, the initial grouping 126 may be selected to be the grouping 104 associated with the lowest wager size 112, or the highest wager size 112. Alternatively, the initial grouping 126 may be selected to be one of the other groupings 104. In FIG. 5, the 9-level jackpot ladder of FIG. 1 is shown, and the grouping 104 associated with the 3^{rd}-highest wager size 112 has been selected as the initial grouping 126. The remaining groupings 104 (as well as jackpot levels 102 that are not in the initial grouping 126) have been “greyed” out for viewing convenience.

After the initial grouping 126 has been selected, the feed RTPs 124 for each jackpot level 102 in the initial grouping 126 may be determined by multiplying the total feed RTP 118 for that jackpot level 102 by the seed value 106 for that jackpot level 102 and dividing by the sum of the seed values 106 associated with all of the jackpot levels 102 in the initial grouping 126. For example, in FIG. 5, the feed RTP 124 for the C jackpot level 102 may be calculated by multiplying the total feed RTP 118 of 6.598% for the initial grouping 126 by the seed value 106 of $252.50 for the C jackpot level 102 and dividing by the sum of all of the seed values 106 for the jackpot levels 102 in the initial grouping 126, i.e., dividing by $252.50+$101+$60.60=$414.10. The result of this calculation is 4.023%, which is the feed RTP 124 for the C jackpot level in the initial grouping 126. Similarly, the feed RTP 124 for the D jackpot level 102 in the initial grouping 126 is 6.598%*$101/$414.40=1.609%, and the feed RTP 124 for the E jackpot level 102 in the initial grouping 126 is 6.598%*60.60/$414.40=0.966%.

After determining the feed RTPs 124 for all of the jackpot levels 102 in the initial grouping 126, the feed RTPs 124 for the jackpot levels 102 in the remaining groupings 104 may be determined. The feed RTPs 124 of each jackpot level 102 in a particular remaining grouping may be at least somewhat dependent on the feed RTPs 124 that have already been determined for an adjacent grouping 104. The feed RTPs 124 for the grouping in question may be determined in one of two ways, depending on various factors. This technique is discussed in the following paragraphs.

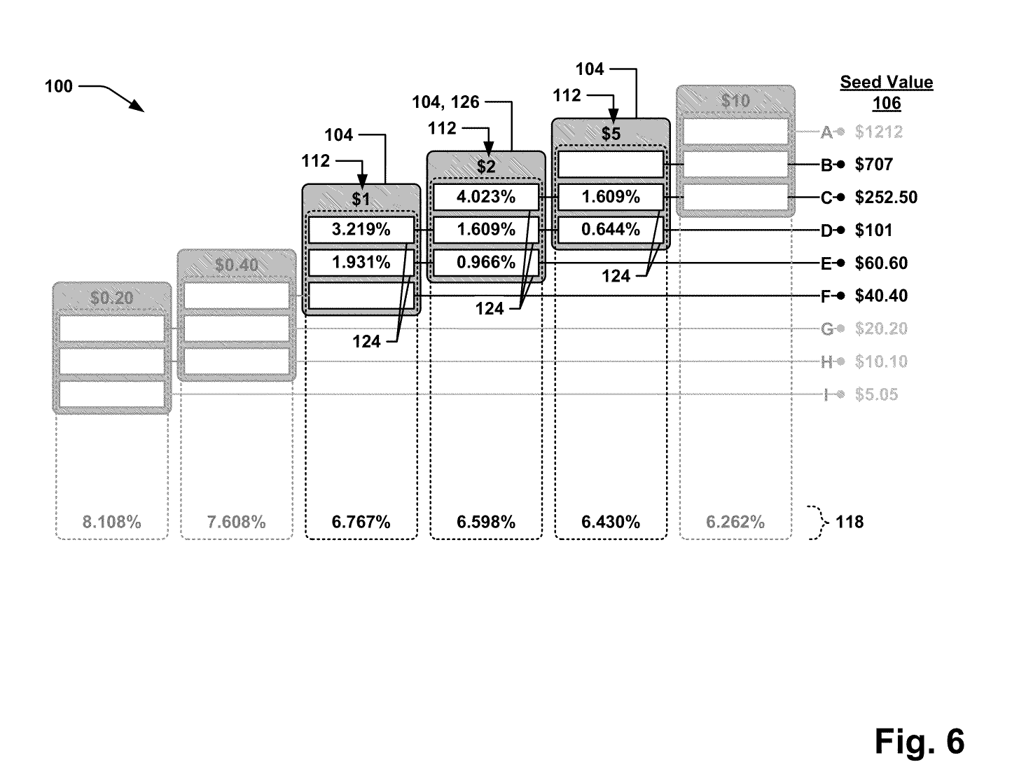

FIG. 6 depicts the 9-level jackpot ladder of FIG. 1 and some feed RTPs for jackpot level groupings adjoining the initial grouping. As can be seen, the groupings 104 associated with the $1 wager size 112 and the $5 wager size 112 are the focus of FIG. 6 (as indicated by the reversion of these groupings 104 from being “greyed out” to being in black and white). A feed RTP 124 may be determined for each jackpot level 102 in these two groupings 124 that corresponds with a previously-determined feed RTP 124 in another grouping 124, e.g., the initial grouping 126, by multiplying the previously-determined feed RTP 124 by the wager size 112 for the grouping 104 associated with the previously-determined feed RTP 124 and then dividing by the wager size 112 associated with the grouping 104 in question. For example, for the D jackpot level 102 in the grouping 104 associated with the $1 wager size 112, there is a previously-determined feed RTP 124 of 1.609% for the D jackpot level 102 in another grouping 104 (the initial grouping 126, in this case), so the feed RTP 124 for the D jackpot level 102 in the grouping 104 associated with the $1 wager size 112 may be determined by multiplying the previously-determined feed RTP 124 of 1.609% by the $2 wager size 112 associated with the initial grouping 126 and dividing by the $1 wager size 112, i.e., 1.609%*$2/$1=3.219% (there is some minor inconsistency in these numbers due to rounding error; the RTP values discussed in this document have typically been rounded to the nearest thousandth, but the calculations performed have been exact). Similarly, the feed RTP 124 for the D jackpot level 102 in the grouping 104 associated with the $5 wager size 112 may be calculated by multiplying 1.609% by the $2 wager size and dividing by the $5 wager size, i.e., 1.609%*$2/$5=0.644%. A similar determination may be performed for the C jackpot level 102 in the grouping 104 associated with the $5 wager size 112, i.e., the feed RTP 124 for the C jackpot level 102 in this grouping may be 4.023%*$2/$5=1.609%. A further similar determination may be performed for the E jackpot level 102 in the grouping 104 associated with the $1 wager size 112, i.e., the feed RTP 124 for the E jackpot level 102 in this grouping may be 0.966%*$2/$1=1.931%.

For the remaining feed RTPs 124 in the groupings 104 associated with the $1 and $5 wager sizes 112, any feeds RTP 124 may be selected such that the sum of all of the feed RTPs 124 within the selected feed RTP 124's grouping 104 equals, or substantially equals, the total feed RTP 118 for that grouping 104. For example, the feed RTP 124 for the F jackpot level 102 in the grouping 104 associated with the $1 wager size 112 may be selected such that the sum of 3.219%, 1.931%, and the selected feed RTP 124 equals 6.767%, i.e., the selected feed RTP 124 for the F jackpot level 102 in the grouping 104 associated with the $1 wager size 112 may be 1.617%.

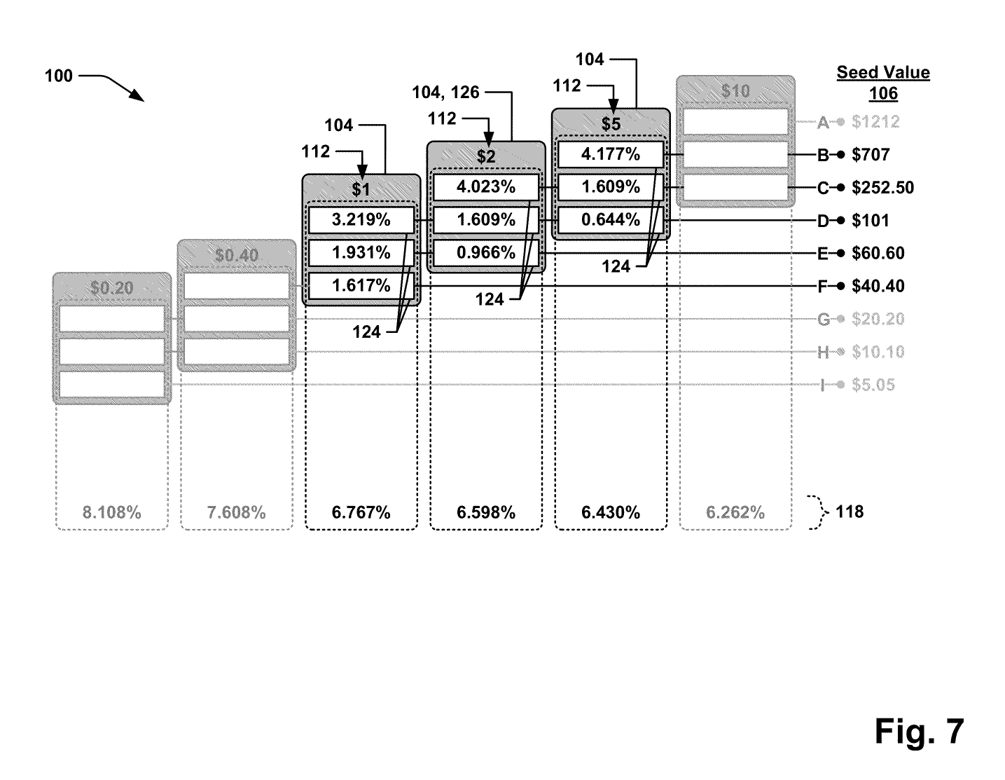

Similarly, the feed RTP 124 for the B jackpot level 102 in the grouping 104 associated with the $5 wager size 112 may be selected such that the sum of 0.644%, 1.609%, and the selected feed RTP 124 equals 6.430%, i.e., the selected feed RTP 124 for the B jackpot level 102 in the grouping 104 associated with the $5 wager size 112 may be 4.177%. FIG. 7 depicts the 9-level jackpot ladder of FIG. 6 as well as the remaining feed RTPs for the jackpot level groupings adjoining the initial grouping.

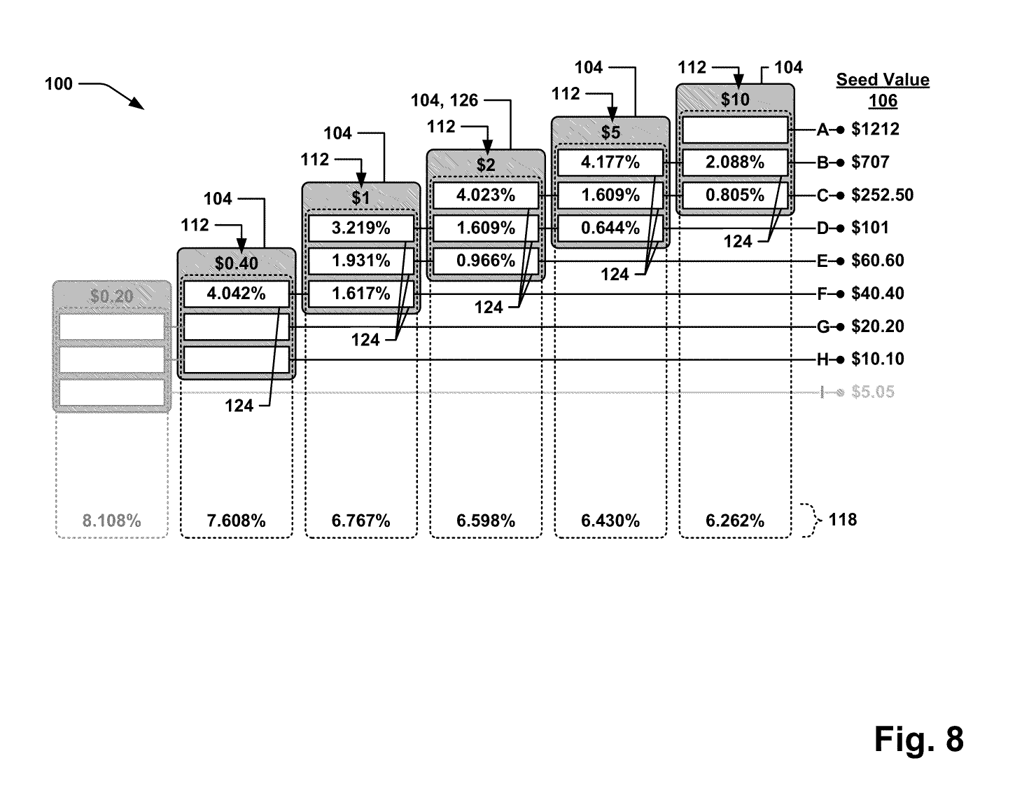

FIG. 8 depicts the 9-level jackpot ladder of FIG. 7 and some feed RTPs for further jackpot level groupings adjoining the groupings adjoining the initial grouping. In FIG. 8, similar to FIG. 6, additional feed RTPs 124 have been determined.

As can be seen, the groupings 104 associated with the $0.40 wager size 112 and the $10 wager size 112 are the focus of FIG. 8 (as indicated by the reversion of these groupings 104 from being “greyed out” to being in black and white). A feed RTP 124 may be determined for each jackpot level 102 in these two groupings 124 that corresponds with a previously-determined feed RTP 124 in another grouping 124, e.g., the groupings 124 associated with the $1 and $5 wager sizes 112, by multiplying the previously-determined feed RTP 124 by the wager size 112 for the grouping 104 associated with the previously-determined feed RTP 124 and then dividing by the wager size 112 associated with the grouping 104 in question. For example, for the F jackpot level 102 in the grouping 104 associated with the $0.40 wager size 112, there is a previously-determined feed RTP 124 of 1.617% for the F jackpot level 102 in another grouping 104 associated with the $1 wager size, so the feed RTP 124 for the F jackpot level 102 in the grouping 104 associated with the $0.40 wager size 112 may be determined by multiplying the previously-determined feed RTP 124 of 1.617% by the $1 wager size 112 associated with the grouping 104 for the previously-determined feed RTP 124 and dividing by the $0.40 wager size 112, i.e., 1.617%*$1/$0.40=4.042%. Similarly, the feed RTP 124 for the B jackpot level 102 in the grouping 104 associated with the $10 wager size 112 may be calculated by multiplying 4.177% by the $5 wager size and dividing by the $10 wager size, i.e., 4.177%*$5/$10=2.088%. A similar determination may be performed for the C jackpot level 102 in the grouping 104 associated with the $10 wager size 112, i.e., the feed RTP 124 for the C jackpot level 102 in this grouping may be 1.609%*$5/$10=0.805%.

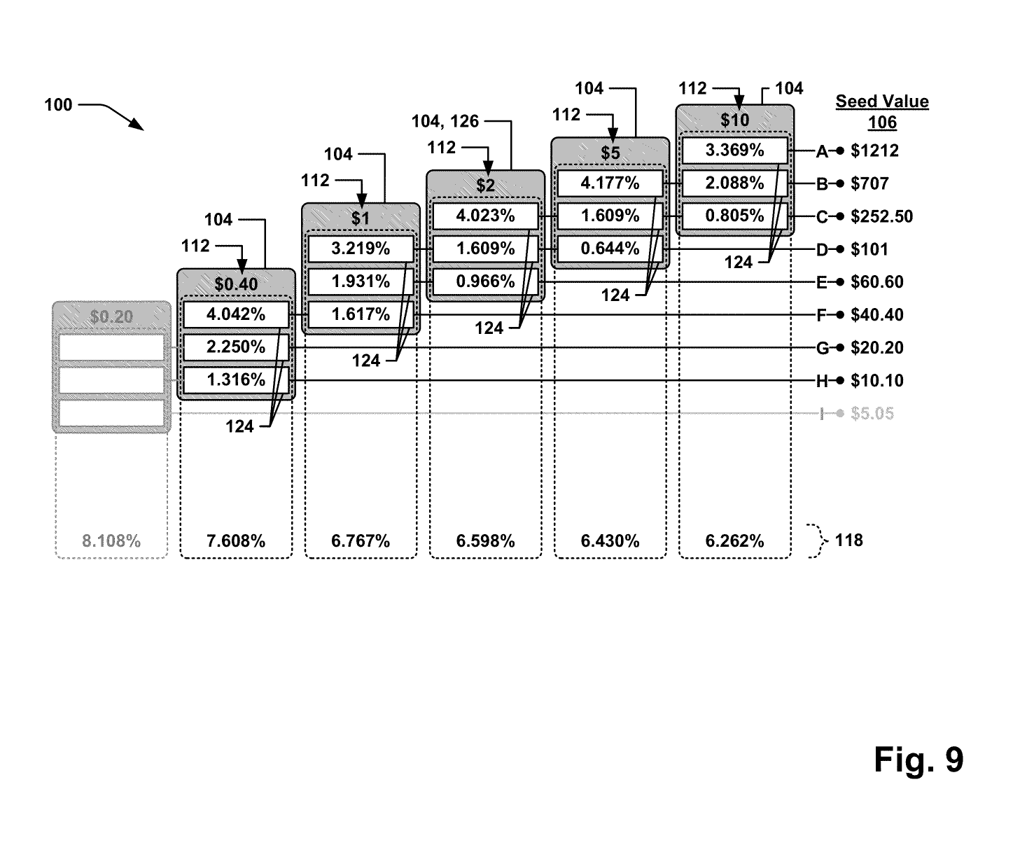

FIG. 9 depicts the 9-level jackpot ladder of FIG. 8 as well as the remaining feed RTPs for the groupings considered in FIG. 8. The undetermined feed RTPs 124 for the groupings 104 associated with the $0.40 and the $10 wager sizes 112 may be determined in a manner similar to that discussed above with respect to FIG. 7. For example, the feed RTPs 124 for the G and H jackpot levels 102 in the grouping 104 associated with the $0.40 wager size 112 may be selected to be any non-negative values that result in the sum of all the feed RTPs 124 for that grouping 104 equaling the total feed RTP 118 for that grouping 104. Thus, for example, the G and H jackpot levels 102 for the grouping 104, when added to the 4.042% feed RTP 124 already determined, must equal 7.608%. Accordingly, the G jackpot level 102 feed RTP 124 has been selected to be 2.250% and the H jackpot level 102 feed RTP 124 has been selected to be 1.316%. Other combinations of feed RTPs 124 could be selected for these two jackpot levels 102 as well, but these particular values were selected because they generally follow the trends seen within other groupings 104.

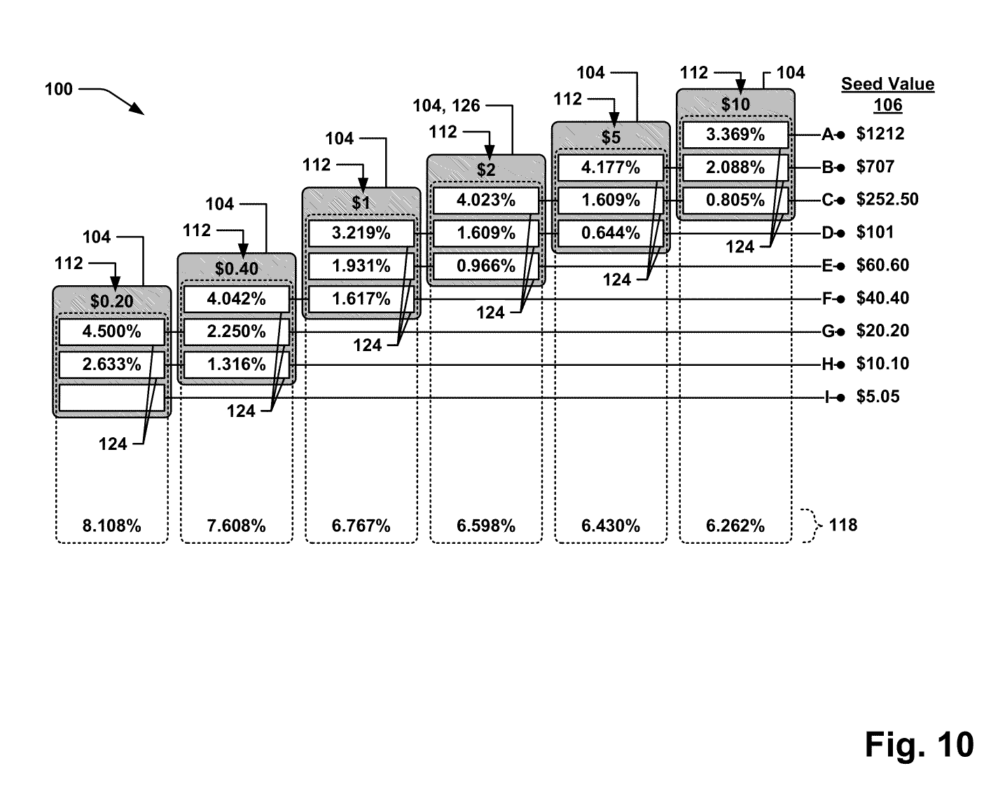

FIG. 10 depicts the 9-level jackpot ladder of FIG. 9 and some feed RTPs for the lowest wager size jackpot level grouping. As can be seen, the grouping 104 associated with the $0.20 wager size 112 is the focus of FIG. 10 (as indicated by the reversion of this grouping 104 from being “greyed out” to being in black and white). A feed RTP 124 may be determined for each jackpot level 102 in this grouping 124 that corresponds with a previously-determined feed RTP 124 in another grouping 124, e.g., the grouping 124 associated with the $0.40 wager size 112, by multiplying the previously-determined feed RTP 124 by the wager size 112 for the grouping 104 associated with the previously-determined feed RTP 124 and then dividing by the wager size 112 associated with the grouping 104 in question. For example, for the G jackpot level 102 in the grouping 104 associated with the $0.20 wager size 112, there is a previously-determined feed RTP 124 of 2.250% for the G jackpot level 102 in another grouping 104 associated with the $0.40 wager size, so the feed RTP 124 for the G jackpot level 102 in the grouping 104 associated with the $0.20 wager size 112 may be determined by multiplying the previously-determined feed RTP 124 of 2.250% by the $0.40 wager size 112 associated with the grouping 104 for the previously-determined feed RTP 124 and dividing by the $0.20 wager size 112, i.e., 2.250%*$0.40/$0.20=4.500%. Similarly, the feed RTP 124 for the H jackpot level 102 in the grouping 104 associated with the $0.20 wager size 112 may be calculated by multiplying 1.316% by the $0.40 wager size and dividing by the $0.20 wager size, i.e., 1.316%*$0.40/$0.20=2.633%.

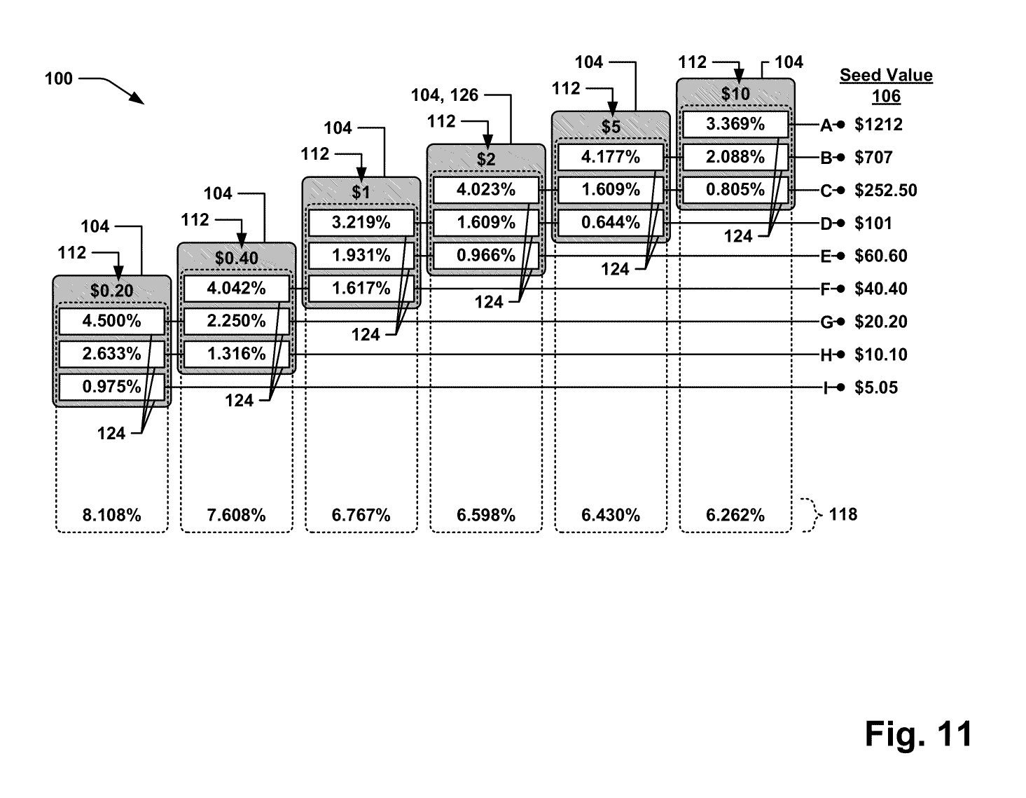

FIG. 11 depicts the 9-level jackpot ladder of FIG. 10 as well as the remaining feed RTP for the lowest wager size jackpot level grouping. In this case, the remaining feed RTP 124 for the grouping 104 associated with the lowest wager size 112 may be calculated in a manner similar to that discussed with respect to FIG. 9. For example, the last remaining feed RTP 124 may be selected such that the sum of this last feed RTP 124, 4.500%, and 2.633% equals 8.108%, i.e., the last remaining feed RTP 124 may be 0.975%.

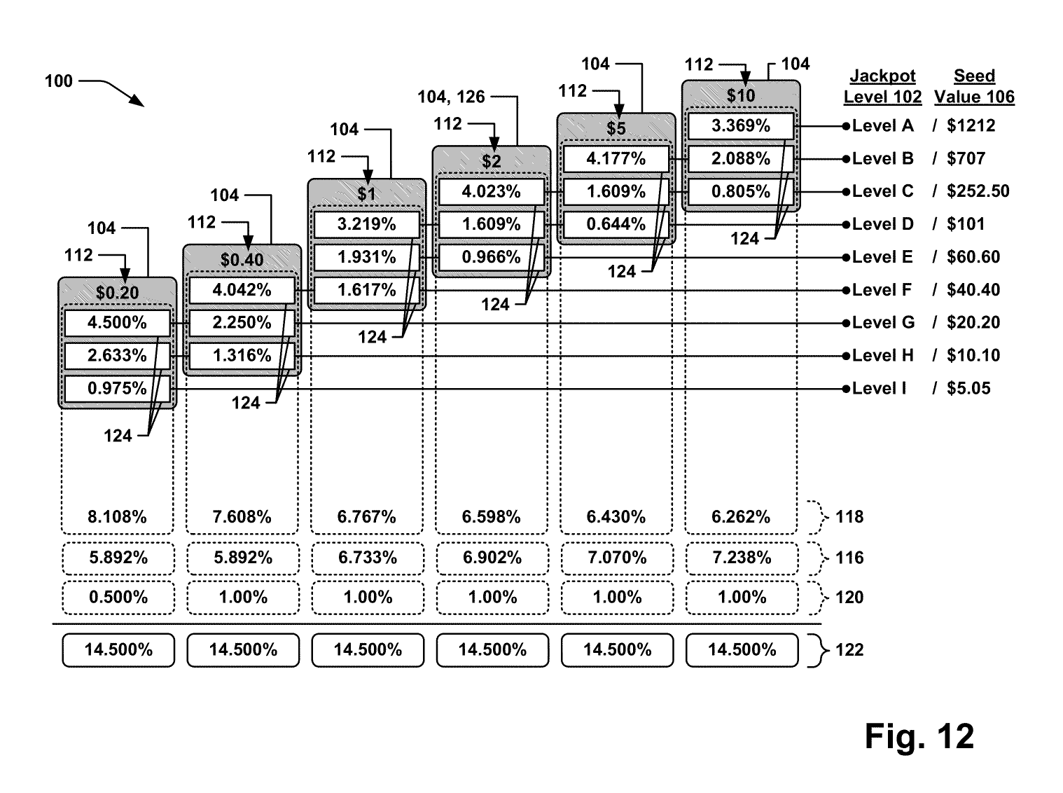

FIG. 12 depicts the 9-level jackpot ladder of FIG. 10 as well as RTP values from feed, seed, and injection. As can be seen, the sums of the total seed RTP 116, the total injection RTP 120, and the total feed RTP 118 for each grouping are all equal to the total jackpot RTP 122 of 14.5%.

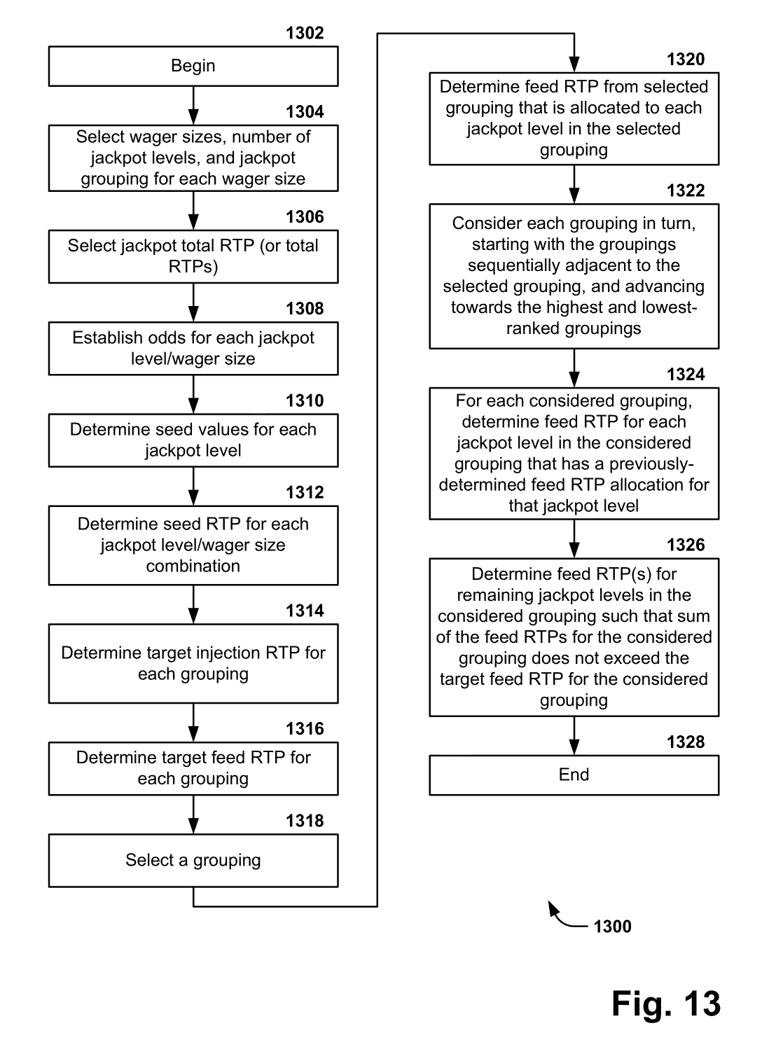

The above technique for calculating feed RTPs for each jackpot level 102 and corresponding wager size 112 is summarized in FIG. 13, which depicts a flow diagram of one example technique for implementing a multi-level, multi-stake progressive jackpot with overlapping eligibility bands. It is to be understood that the order of the blocks shown may not represent a fixed order of performance of those blocks (although some relative ordering may be inherent, e.g., if one block is dependent on the results of another block).

The technique may begin in block 1302. In block 1304, wager sizes 112 may be selected, as well as the number of jackpot levels 102, and the groupings 104 for each wager size 112. In block 1306, the total jackpot RTPs 122 may be determined. These may, as in the example discussed above, be the same for all of the jackpot levels 102 in the jackpot ladder 100, although other implementations may feature different total jackpot RTPs 122 that differ between some or all of the jackpot levels 102 in the jackpot ladder 100. In block 1308, the odds of winning each jackpot level 102 in each different grouping may be established. The odds may, as in the example discussed above, be the same, or substantially the same, from grouping 104 to grouping 104 for a give jackpot level. For example, the odds used in the example above were 1000 to 1, although odds of 1002 to 1, 1000 to 1, 997 to 1, etc. may all be viewed as substantially the same odds. In some implementations, the odds may differ significantly from jackpot level 102 to jackpot level 102, although such implementations may not be compliant with gaming regulations and may prove to be much more difficult to implement.

In block 1310, the seed values 106 for each jackpot level may be determined. As discussed above, such seed values 106 may be apportioned between “show now” and “pre-growth” amounts, although both amounts may be summed together to determine each seed value 106.

In block 1312, the seed RTP for each jackpot level 102/grouping 104 may be determined. For example, the seed RTP for a given jackpot level 102/grouping 104 may be determined by dividing the seed value 106 for that jackpot level 102 by the product obtained by multiplying the wager size 112 for that grouping 104 by the odds of winning that jackpot level 102. This determination may be performed for each jackpot level 102/grouping 104 combination.

In block 1314, a target total injection RTP 120 for each wager size 112 may be determined or established. The injection may be specified as an RTP or as an amount of funding earmarked for injection into the meter(s) during play, e.g., to give the appearance of player activity during non-peak hours. If the injection is specified as an amount of funding, block 114 may involve transforming the amount of earmarked injection funding into an RTP by dividing the amount of earmarked injection funding by the product obtained by multiplying the wager size 112 for that grouping 104 by the odds of winning that jackpot level 102. Injection RTP may be distributed across the meters for the jackpot levels 102 for a grouping 104 using a variety of different techniques. For example, in some implementations, injection funding may be evenly split amongst the meters within a grouping 104. In other implementations, injection funding may be apportioned differently. The injection rate between meters in a grouping 104 may be uniform in some implementations and non-uniform in other implementations.

In block 1316, the total feed RTP 118 for each grouping 104 may be determined by subtracting the sum of all of the seed RTPs 114, i.e., the total seed RTP 116, and the total injection RTP 120 of the grouping 104 from the total jackpot RTP 122.

In block 1318, an initial grouping 126 may be selected from the groupings 104. As discussed above, in some implementations, any of the groupings 104 may be selected as the initial grouping 126, although certain groupings 104 may result in a computationally more simple implementation, e.g., selecting a grouping 104 associated with the highest or lowest wager size 112 may allow iterating through the groupings 104 in only one direction instead of two directions. It is also to be understood that it is not necessary to determine the feed RTPs 124 for all of the jackpot levels in a grouping 104 before starting to determine the feed RTPs 124 for another grouping 104. Some flexibility in the order of computing the feed RTPs 124 exists. For example, if a feed RTP 124 for a jackpot level has been determined for one grouping, the feed RTP 124 for that jackpot level 102 in every other grouping 104 including that jackpot level 102 may be determined regardless of whether all of the feed RTPs 124 for jackpot levels 102 in intervening groupings 104 have been determined.

In block 1320, the feed RTP 124 for each jackpot level 102 in the initial grouping 126 may be determined by multiplying the total feed RTP 118 for that jackpot level 102 by the seed value 106 for that jackpot level 102 and dividing by the sum of the seed values 106 associated with all of the jackpot levels 102 in the initial grouping 126.

After establishing the feed RTPs 124 in the initial grouping 104, the feed RTPs in the remaining groupings 104 may be determined in block 1322. In block 1322, each remaining grouping 104, when ranked by associated wager size 112, may be considered in turn, starting with the grouping(s) 104 immediately adjacent to the initial grouping 126 and progressing towards the grouping or groupings 104 associated with the highest, lowest, or highest and lowest wager sizes 112.

In block 1324, for each considered grouping, a feed RTP 124 may be determined for each jackpot level 102 in the considered grouping that has a previously-determined feed RTP 124 in another grouping 104 (including the initial grouping 126). The feed RTP 124 in such cases may be determined by multiplying the previously-determined feed RTP 124 by the wager size 112 for the grouping 104 associated with the previously-determined feed RTP 124 and then dividing by the wager size 112 associated with the considered grouping 104.

In block 1326, the feed RTPs 124 not determinable according to block 1324 may be determined, i.e., feed RTPs 124 for jackpot levels 102 that do not have a previously-determined feed RTP in a grouping 104 other than the considered grouping 104. Such feed RTPs 124 may be determined by selecting values such that the sum of all of the feed RTPs 124 within the considered grouping 104 equals, or substantially equals, the total feed RTP 118 for the considered grouping 104. In groupings 104 where only one such feed RTP 124 exists, this may reduce to a single-degree-of-freedom problem with only one answer. In groupings 104 where multiple feed RTPs 124 exist, this may turn into a multiple-degree-of-freedom problem, and the person or entity configuring the jackpot ladder 100 may have considerable freedom to select values for such feed RTPs 124 that satisfy the constraints imposed. In block 1328, the technique may end.

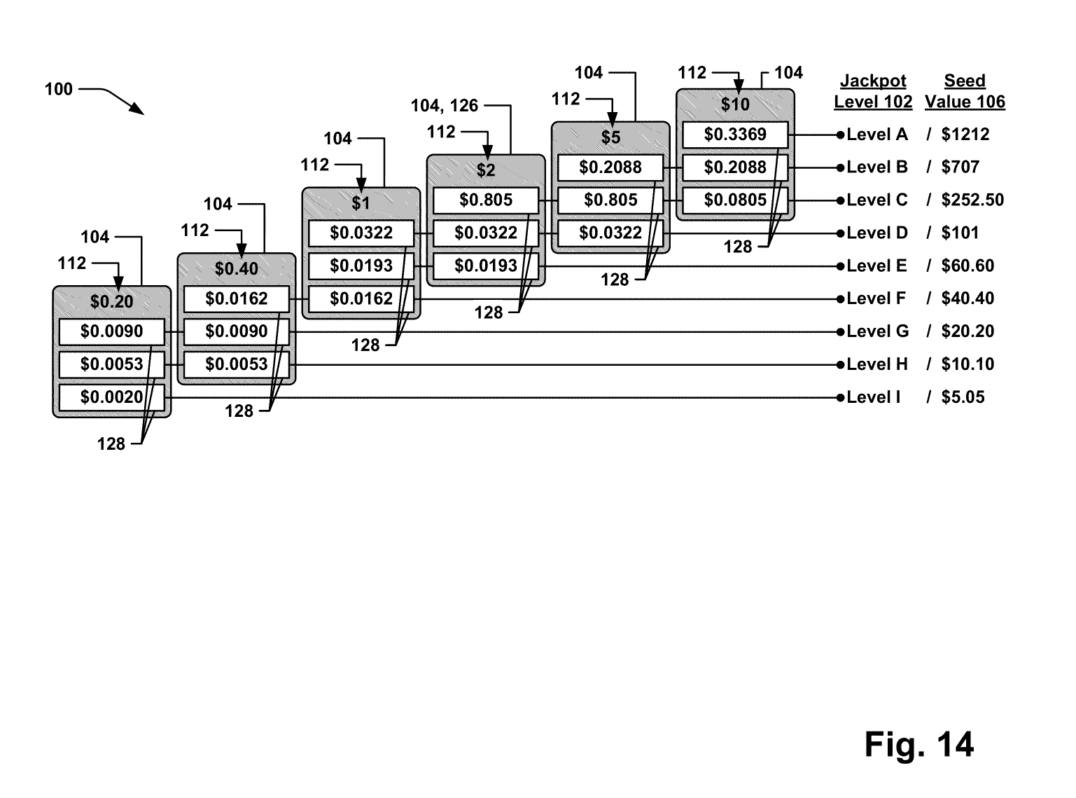

Once the feed RTPs for each jackpot level 102 in each grouping 104 have been determined, each such feed RTP may be used to determine the portion of each wager of each wager size 112 that is to be used to fund jackpot level 102. FIG. 14 depicts the 9-level jackpot ladder of FIG. 12 but has replaced the feed RTPs 124 shown in FIG. 12 with the monetary contribution 128 from wager size 112 associated with each grouping 104 that will be used to fund the respective jackpot level 102. The monetary contribution 128 that will be used to fund a particular jackpot level may be determined by multiplying the associated wager size 112 by the feed RTP 124 for that jackpot level 102 in the grouping 104 associated with that wager size 112. For example, for the $10 wager size, $10*3.369%=$0.3369 of every $10 wager will be contributed to the A jackpot level 102; $10*2.088%=$0.0288 of every $10 wager will be contributed to the B jackpot level 102; and $10*0.805%*$10=$0.0805 of every $10 wager will be contributed to the C jackpot level 102. As can be seen, the monetary contribution 128 to each jackpot level 102 in this example does not vary across the groupings 104 that the jackpot level 102 is in. This allows the jackpot odds to be consistent across groupings 104 (assuming that the progressive jackpot game is offered in a jurisdiction that requires that players' chances of winning scale with regard to the amount of their monetary contribution to the jackpot), and may result in an easier-to-understand game for players. In some implementations, however, the monetary contributions 128 may differ from grouping 104 to grouping 104, and the jackpot odds may, accordingly, need to be adjusted from grouping 104 to grouping 104.

Once the above parameters have been established, a progressive jackpot game utilizing the jackpot ladder may be offered. The progressive jackpot game may allow players making wagers equal to the wager sizes 112 to participate, and, in return, may divert portions of each such wager corresponding to the monetary contribution 128 for the corresponding wager size 112 from these wagers. For each such wager, a determination may be made as to whether the wager wins one or more of the jackpot levels 102 for which it is eligible. Such a determination may be randomly determined using, for example, a random number generator and according to the odds established for that jackpot level. For any jackpot level 102 that experiences a “win” condition, the funds accumulated in that jackpot level 102 may be paid out to the winning player, i.e., the seed value 106, whatever funds have been added by way of injection, and whatever monetary contributions 128 have been received by way of feed.

Accordingly, a multi-progressive jackpot game according to the techniques and structures outlined herein may be offered by establishing desired jackpot levels 102, odds of winning each jackpot level, wager sizes 112, groupings 104, monetary contributions 128, and other parameters discussed above, and then designating one or more wagering games allowing wager sizes corresponding to one or more of the wager sizes 112. Each designated wagering game may allow all of the wager sizes 112, or just a subset of the wager sizes 112. For example, with reference to the example discussed above, game A may allow $0.20, $0.40, $1, $2, and $5 wagers, and game B may allow $3, $5, and $10 wagers (the $3 wager would not be eligible to participate in the example jackpot ladder 100 since there is no $3 wager size 112 in the jackpot ladder 100). Game A would be eligible to participate in the B-I jackpot levels 102, depending on wager size, and game B would be eligible to participate in the A-D jackpot levels 102, depending on wager size. In some implementations, a designated wagering game may allow wager sizes corresponding to all of the wager sizes 112 for a given jackpot ladder 100. Such a wagering game would be eligible to participate in the A-I jackpot levels 102, depending on wager size.

For each such designated wagering game, each wager placed may be evaluated to determine if the wager corresponds to one of the wager sizes 112. If such correspondence exists, then a portion or portions of that wager corresponding to the monetary contribution or monetary contributions 128 for that wager size 112 and the jackpot level or jackpot levels 102 in the grouping 104 associated with that wager size 112 may be added to the respective meter or meters for the jackpot level or jackpot levels 102 in the grouping 104 associated with that wager size 112. Each such wager may also be evaluated, with respect to each such jackpot level 102, to determine if that wager wins one or more of the jackpot levels 102 that is in the grouping 104 associated with that wager size 112, as discussed above. Note that it is theoretically possible to win multiple jackpot levels 102 within a grouping 104 simultaneously, i.e., as a result of placing one particular wager of the associated wager size 112, but the probability of doing so is quite small compared with the probability of winning a single jackpot level 102 (or no jackpot levels 102).

While such a jackpot ladder system 100 may be implemented in a casino setting or across multiple casino properties, the jackpot ladder system 100 may also be implemented in an Internet gaming context (or a combination of Internet and casino-based gaming). A server or servers may keep track of the various aspects of such a jackpot ladder, e.g., the meter values for each jackpot level 102, whether or not a particular wager is eligible to win a particular jackpot level 102 based on whether the wager is from one of the designated wagering game and of a size corresponding to the wager size 112 associated with a grouping 104 including that particular jackpot level 02, which player or gaming machine is associated with that wager, whether or not the wager wins any of the jackpot levels 102, and so forth. The server or servers may also be programmed to or configured to facilitate configuration of a jackpot ladder 100 by performing most, if not all, of the actions discussed above with respect to the detailed example. The server or servers may also be configured to obtain various parameters used to set up a jackpot ladder, such as those discussed above, via user input or via reference to machine-readable data files provided by a gaming operator or manufacturer.

Some particular implementations of a jackpot ladder 100, such as a jackpot ladder similar to that discussed in the above in-depth example, may, as discussed above, have several notable characteristic features. For example, for such a jackpot ladder 100, the jackpot odds for a jackpot may remain the same between different wager sizes, the odds of winning a jackpot may be the same for each jackpot level 102 within each grouping 104, and the total jackpot RTP for each jackpot level may remain the same between wager sizes.

In other implementations, however, these characteristic features may be different. For example, some jackpot ladders 100 may feature different odds between jackpot levels 102 within the jackpot ladder 100. For example, in a three-jackpot level 102 grouping 104, the odds may be set so that the middle jackpot level 102 has one twice the chance of being won that the highest jackpot level 102 in the grouping 104 has, and so that the lowest jackpot level 102 in the grouping has twice the chance of being won that the middle jackpot level has. The odds for each jackpot level in each grouping may also be set using techniques other than equiprobable odds or geometric progression odds.

The odds of winning a given jackpot level 102 may also be varied between groupings 104, although doing so may require that the mathematics driving the game be altered (common odds are mathematically simpler to handle). In effect, each wager's chance of winning would need to be calculated differently.

If the wager sizes 112 are selected to follow a constant geometric series, e.g., $0.25, $0.50, $1.00, $2.00, $4.00, $8.00, etc., such a jackpot ladder 100 may, in some implementations, also feature relative jackpot level RTPs that are equal between groupings 104. For example, if each grouping has 3 jackpot levels, the highest jackpot levels in the groupings 104 may have similar jackpot RTPs, and the lowest jackpot levels in the groupings 104 may have other, similar jackpot RTPs. This may allow higher-wager wagers in each grouping to be rewarded with a higher jackpot RTP than the lower-wager wagers in the groupings. In the example discussed in detail above, such is not the case, although the total jackpot RTP for each grouping is the same.

In some implementations, the total jackpot RTP may also be varied from grouping to grouping rather than kept the same. This may encourage higher wagering if the groupings associated with higher wagers have higher total jackpot RTPs.

In some implementations, the number of jackpot levels 102 within each grouping 104 may be the same, as in the detailed example, or one or more of the groupings 104 may have a different number of jackpot levels 102.

In some implementations, the jackpot ladder may be implemented using “as-is” prizes, e.g., prizes that do not grow in value with each wager placed (in other words, non-progressive prizes). For example, each jackpot level may award a different car, with the topmost jackpot level awarding a high-end car, and the lowest jackpot level awarding a lower-end car (with assorted gradations of vehicles for jackpot levels in between). In such cases, the overall jackpot RTP for each grouping may be determined by dividing the value of the as-is prize (this may be calculated based on the value to the player or the outlay by the prize provider, which will usually be a lower value) by the product of the odds for that jackpot level multiplied by the wager size for that grouping. This may then allow a feed RTP to be calculated that is appropriate for that as-is prize in a manner similar to how the feed RTPs are calculated in the detailed example. In some implementations, jackpot levels with “as-is” prizes may be intermingled with jackpot levels with actual progressive awards.

If desired, the jackpot ladders discussed herein may also be presented along with one or more non jackpot ladder progressive jackpot awards, i.e., progressive jackpot awards that do not involve groupings 104. These non jackpot ladder progressive jackpot awards may be separately-controlled progressive games, but may be presented in a manner that makes them look like they are part of the overall jackpot ladder.

There are several advantages of the jackpot ladder system described herein. For example, such systems may, in some implementations, provide all players with the same odds of winning a jackpot regardless of wager size (in such implementations, the wager size would, however, control which jackpot levels could be won). Such an implementation is more exciting for lower-wager players than, for example, a system where lower-wager players have lower odds. In on-line wagering systems, the bet ranges may be much larger than in casino-based systems, e.g., 50× to 200× the base wager amount as compared to 3× to 5× the lowest wager amount; if the odds of winning are tied to wager size in such on-line systems, lower-wager players may grow dissatisfied. A jackpot ladder system configured with equal odds between bet levels (or unequal, but more equitable—e.g., comparable to casino-based systems) may be more likely to maintain lower-wager player interest.

Another advantage is apparent when one considers that many jurisdictions require that the odds of winning a jackpot change perfectly linearly with respect to the wager sizes of the wagers eligible to win the jackpot. This keeps the average jackpot RTP the same. A jackpot ladder according to the concepts disclosed herein may feature the same overall RTP . . .

Many (most?) jurisdictions require odds to change perfectly linear to wager size—which keeps average jackpot RTP the same. My invention also allows for average jackpot RTP to remain the same between bet sizes.

Yet another advantage of a jackpot ladder as described herein is that players are less likely to “abandon” a particular jackpot when that jackpot is won. For example, if players can participate in jackpots A and B by placing $1 and $2 wagers, respectively, players may abandon jackpot A after jackpot A is won and concentrate instead on jackpot B. If jackpots A and B are together in a grouping of a jackpot ladder as described herein, however, players wishing do concentrate on jackpot B will still have a portion of their wagers directed to jackpot A, thus maintaining jackpot A's feed and preventing jackpot A from going stagnant.

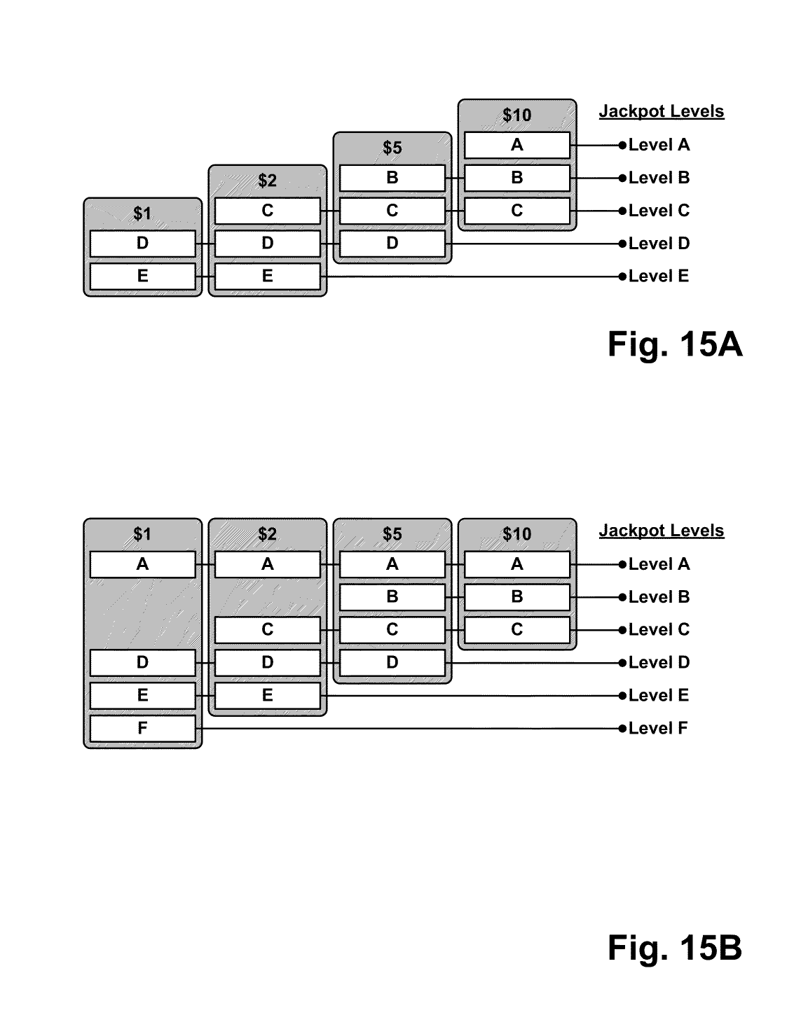

Other implementations of jackpot ladders are shown in FIGS. 15A and 15B. In FIG. 15A, a jackpot ladder is shown in which the lowest wager size grouping has only two jackpot levels (both of which are also in the $2 wager size grouping). Such a jackpot ladder may be provided using the techniques outlined above, although there may be less flexibility as to which grouping is selected as the initial grouping in some circumstances. For example, in order to provide a uniform total jackpot RTP and injection RTP across all of the wager size groupings shown, it may be necessary to select the lowest wager size grouping as the initial grouping.

In FIG. 15B, a jackpot ladder is shown in which all of the wager size groupings include the highest-ranked jackpot level. Similarly to the jackpot ladder shown in FIG. 15A, in order to provide a uniform total jackpot RTP and injection RTP across all of the wager size groupings shown, it may be necessary to select the highest wager size grouping as the initial grouping (due to all of the jackpot levels in the highest wager size grouping also being included in the $5 wager size grouping).

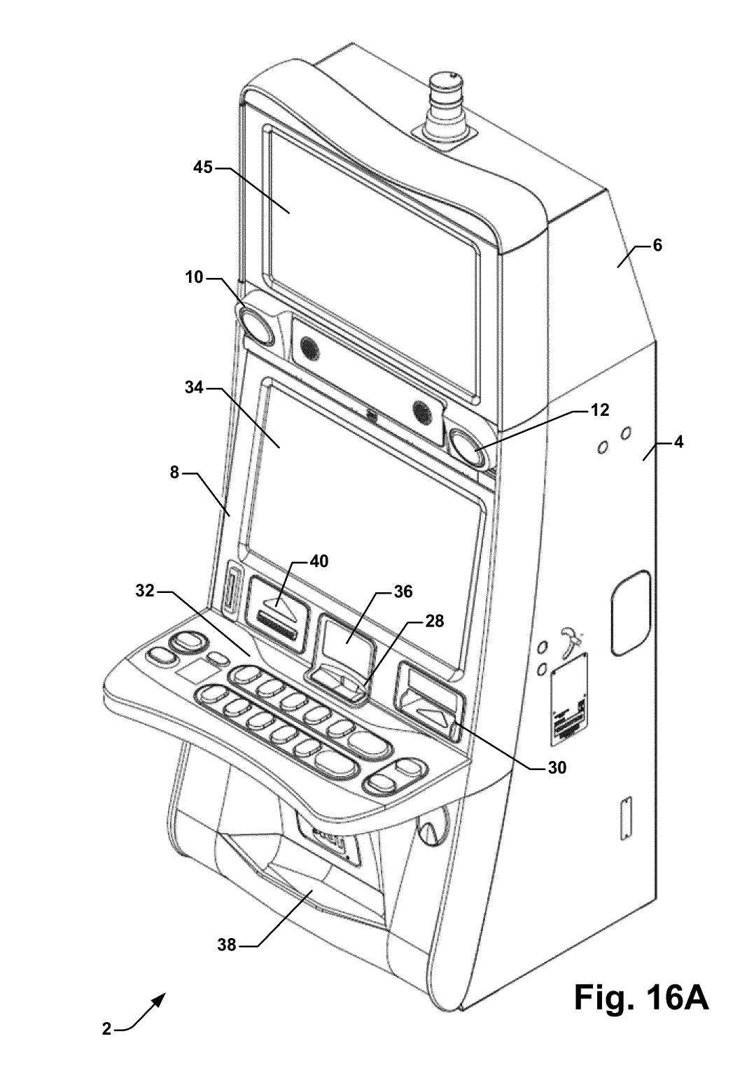

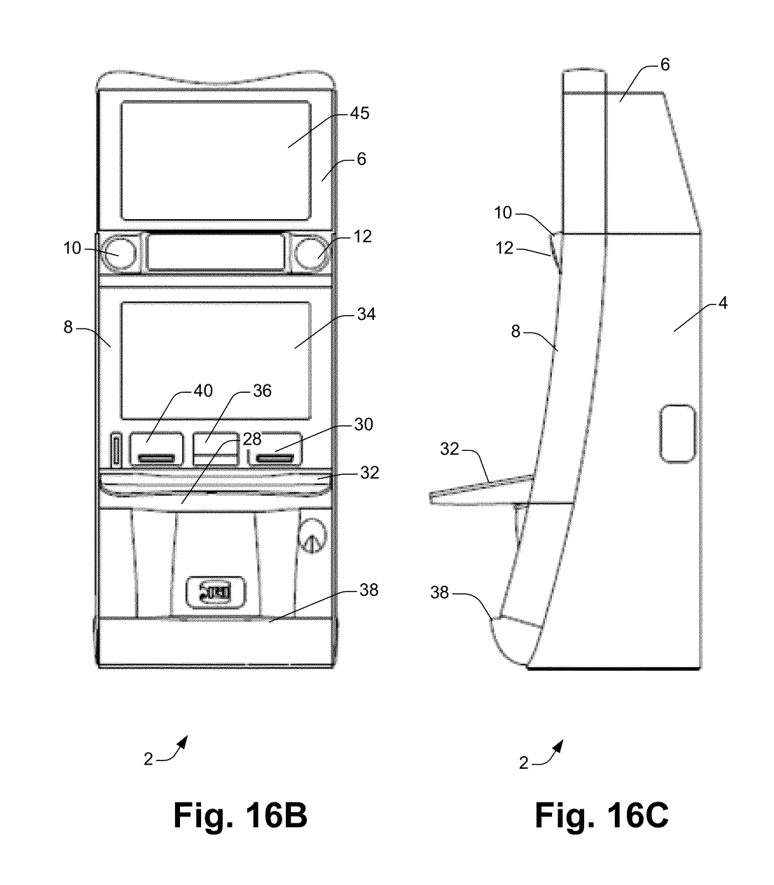

FIGS. 16A, 16B, and 16C show isometric, front, and side views, respectively, of a gaming machine 2, which may be used to support various implementations of multi-stake, multi-level progressive jackpot ladders with overlapping eligibility bands as discussed herein.

As illustrated in FIGS. 16A-16C, gaming machine 2 includes a main cabinet 4, which generally surrounds the machine interior and is viewable by users. The main cabinet includes a main door 8 on the front of the machine, which opens to provide access to the interior of the machine.

In some implementations, the electronic gaming machine may include any of a plurality of devices. For example, the electronic gaming machine may include a ticket printer that prints bar-coded tickets, a key pad for entering player tracking information, a display (e.g., a video display screen) for displaying player tracking information, a card reader for entering a magnetic striped card containing player tracking information, and any other devices. The ticket printer may be used to print tickets for a cashless ticketing system. In FIGS. 16A-16C, attached to the main door is a payment acceptor 28, a bill validator 30, and a coin tray 38. The payment acceptor may include a coin slot and/or a payment, note, or bill acceptor, where the player inserts money, coins, tokens, or other types of payments.

In some implementations, devices such as readers or validators for credit cards, debit cards, smart cards, or credit slips may facilitate payment. For example, a player may insert an identification card into a card reader of the gaming machine. The identification card may be a smart card coded with a player's identification, credit totals (or related data) and other relevant information. As another example, a player may carry a portable device, such as a cell phone, a radio frequency identification tag or any other suitable wireless device. The portable device may communicates a player's identification, credit totals (or related data), and/or any other relevant information to the gaming machine. As yet another example, money may be transferred to a gaming machine through electronic funds transfer. When a player funds the gaming machine, another logic device coupled to the gaming machine may determine the amount of funds entered and display the corresponding amount on a display device.

In some implementations, attached to the main door are a plurality of player-input switches or buttons 32. The input switches can include any suitable devices which enables the player to produce an input signal which is received by the processor. The input switches may include a game activation device that may be used by the player to start any primary game or sequence of events in the gaming machine. The game activation device can be any suitable play activator such as a “bet one” button, a “max bet” button, or a “repeat the bet” button. In some instances, upon appropriate funding, the gaming machine may begin the game play automatically. Alternately, the gaming machine may automatically activate game play after detecting user input via the game activation device.

In some implementations, one input switch is a cash-out button. The player may push the cash-out button and cash out to receive a cash payment or other suitable form of payment corresponding to the number of remaining credits. For example, when the player cashes out, the player may receive the coins or tokens in a coin payout tray. As another example, the player may receive other payout mechanisms such as tickets or credit slips redeemable by a cashier (or other suitable redemption system) or funding to the player's electronically recordable identification card. As yet another example, funds may be transferred from the gaming machine to the player's smart card.

In some implementations, one input switch is a touch-screen coupled with a touch-screen controller, or some other touch-sensitive display overlay to enable for player interaction with the images on the display. The touch-screen and the touch-screen controller may be connected to a video controller. A player may make decisions and input signals into the gaming machine by touching the touch-screen at the appropriate places. One such input switch is a touch-screen button panel.

In some implementations, the gaming machine may include communication ports for enabling communication of the gaming machine processor with external peripherals, such as external video sources, expansion buses, game or other displays, a SCSI port, a key pad, or a network interface for communicating via a network.

In some implementations, the gaming machine may include a label area, such as the label area 36. The label area may be used to display any information or insignia related to activities conducted at the gaming machine. For example, the label area may include a schematic showing the wager sizes 112, groupings 104, and jackpot levels 102 for a particular jackpot ladder 100 in which the gaming machine may be configured to participate.

In some implementations, the electronic gaming machine may include one or more display devices. For example, the electronic gaming machine 2 includes display devices 34 and 45. The display devices 34 and 45 may each include any of a cathode ray tube, an LCD, a light emitting diode (LED) based display, an organic light emitting diode (OLED) based display, a polymer light emitting diode (PLED) based display, an SED based-display, an E-ink display, a plasma display, a television display, a display including a projected and/or reflected image, or any other suitable electronic display device.

In some implementations, the display devices at the gaming machine may include one or more electromechanical devices such as one or more rotatable wheels, reels, or dice. The display device may include an electromechanical device adjacent to a video display, such as a video display positioned in front of a mechanical reel. The display devices may include dual-layered or multi-layered electromechanical and/or video displays that cooperate to generate one or more images. The display devices may include a mobile display device, such as a smart phone or tablet computer, that allows play of at least a portion of the primary or secondary game at a location remote from the gaming machine. The display devices may be of any suitable size and configuration, such as a square, a rectangle or an elongated rectangle.

In some implementations, the display devices of the gaming machine are configured to display game images or other suitable images. The images may include symbols, game indicia, people, characters, places, things, faces of cards, dice, and any other images. The images may include a visual representation or exhibition of the movement of objects such as mechanical, virtual, or video reels and wheel. The images may include a visual representation or exhibition of dynamic lighting, video images, or any other images. The display devices may, for example, be used to display information similar to that discussed above with respect to the label area 36, e.g., jackpot ladder 100 information. Such a display may be in addition to the information displayed in label area 36, or may take the place of such information, i.e., the label area 36 may not include such information.

In some implementations, the electronic gaming machine may include a top box. For example, the gaming machine 2 includes a top box 6, which sits on top of the main cabinet 4. The top box 6 may house any of a number of devices, which may be used to add features to a game being played on the gaming machine 2. These devices may include speakers 10 and 12, display device 45, and any other devices. Further, the top box 6 may house different or additional devices not illustrated in FIGS. 1-2B. For example, the top box may include a bonus wheel or a back-lit silk screened panel which may be used to add bonus features to the game being played on the gaming machine. As another example, the top box may include a display for a progressive jackpot offered on the gaming machine—such a display may, for example, be used to display jackpot ladder 100 information, including, for example, meter values for one or more of the jackpot levels 102 or information such as that discussed above with respect to the label area 36. As yet another example, the top box may include a smart card interaction device. During a game, these devices are controlled and powered, at least in part, by circuitry (e.g. a master gaming controller) housed within the main cabinet 4 of the machine 2.

In some implementations, speakers may be mounted and situated in the cabinet with an angled orientation toward the player. For instance, the speakers 10 and 12 located in top box area 6 of the upper region of gaming machine 2 may be mounted and situated in the cabinet with an angled orientation down towards the player and the floor. In one example, the angle is 45 degrees with respect to the vertical, longitudinal axis of machine 2. In another example, the angle is in a range of 30-60 degrees. In another example, the angle is any angle between 0 and 90 degrees. In some implementations, the angle of speakers in the gaming machine may be adjustable. For instance, speakers may be adjusted to face in a direction more closely approximating an estimated position of a player's head or facial features.

The bill validator 30, player-input switches 32, display screen 34, and other gaming devices may be used to present a game on the game machine 2. The devices may be controlled by code executed by a master gaming controller housed inside the main cabinet 4 of the machine 2. The master gaming controller may include one or more processors including general purpose and specialized processors, such as graphics cards, and one or more memory devices including volatile and non-volatile memory. The master gaming controller may periodically configure and/or authenticate the code executed on the gaming machine.

In some implementations, the gaming machine may include a sound generating device coupled to one or more sounds cards. The sound generating device may include one or more speakers or other sound generating hardware and/or software for generating sounds, such as playing music for the primary and/or secondary game or for other modes of the gaming machine, such as an attract mode. The gaming machine may provide dynamic sounds coupled with attractive multimedia images displayed on one or more of the display devices to provide an audio-visual representation or to otherwise display full-motion video with sound to attract players to the gaming machine. During idle periods, the gaming machine may display a sequence of audio and/or visual attraction messages to attract potential players to the gaming machine. The videos may also be customized for or to provide any appropriate information.

In some implementations, the gaming machine may include a sensor, such as a camera that is selectively positioned to acquire an image of a player actively using the gaming machine and/or the surrounding area of the gaming machine. The sensor may be configured to capture biometric data about a player in proximity to the gaming machine. The biometric data may be used to implement mechanical and/or digital adjustments to the gaming machine. Alternately, or additionally, the sensor may be configured to selectively acquire still or moving (e.g., video) images. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol, animated avatar, or game indicia. In some implementations, the sensor may be used to trigger an attract mode effect. For example, when the sensor detects the presence of a nearby player, the gaming machine may play sound effects or display images, text, graphics, lighting effects, or animations to attract the player to play a game at the gaming machine.

Gaming machine 2 is but one example from a wide range of gaming machine designs on which the techniques described herein may be implemented. For example, not all suitable gaming machines have top boxes or player tracking features. Further, some gaming machines have only a single game display—mechanical or video, while others may have multiple displays. As mentioned previously, the functionality of gaming machines, in the context of the present disclosure, may also be provided by personal computers providing wager gaming via the Internet.

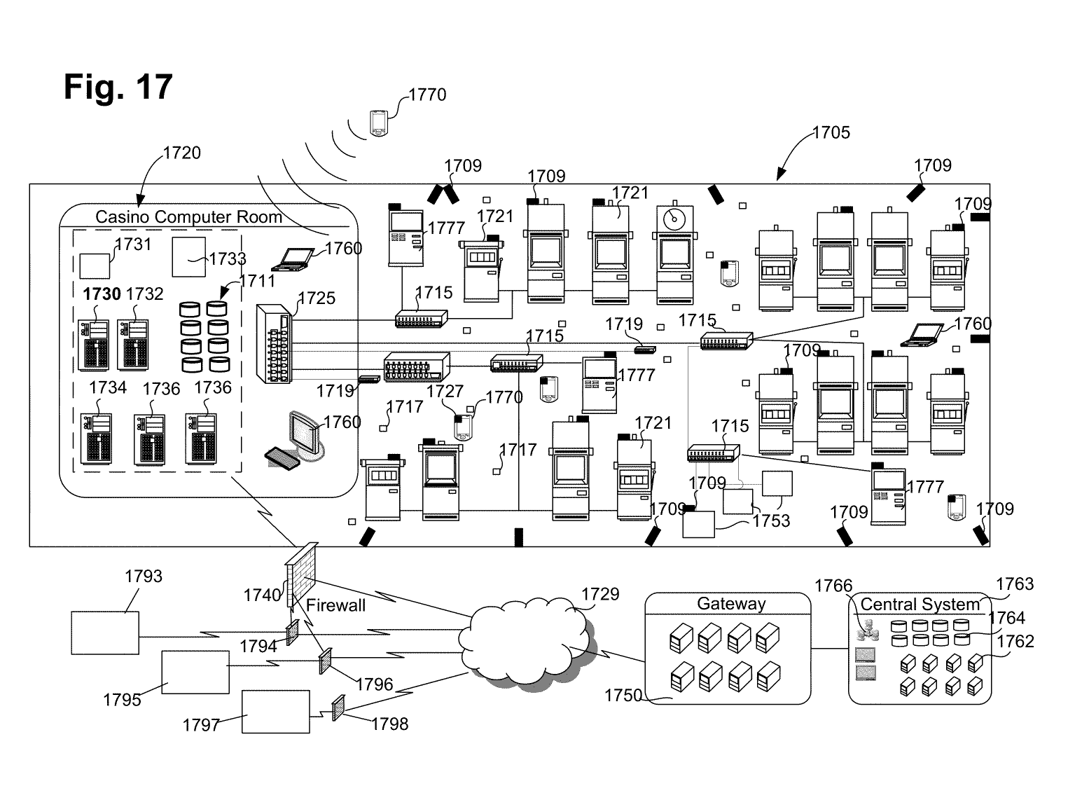

FIG. 17 shows a server-based (sb™) gaming network which may be used to implement some of the techniques or systems as described above. Those of skill in the art will realize that this architecture and the related functionality are merely examples and that the present disclosure encompasses many other such implementations and methods.

Here, casino computer room 1720 and networked devices of a gaming establishment 1705 are illustrated. Gaming establishment 1705 is configured for communication with central system 1763 via gateway 1750. Gaming establishments 1793 and 1795 are also configured for communication with central system 1763. Gaming establishments 1793 and 1795 may, for example, both host gaming machines that may participate in a common jackpot ladder 100.

In some implementations, gaming establishments may be configured for communication with one another. In this example, gaming establishments 1793 and 1795 are configured for communication with casino computer room 1720. Such a configuration may allow devices and/or operators in casino 1705 to communicate with and/or control devices in other casinos. In some such implementations, a server in computer room 1720 may control devices in casino 1705 and devices in other gaming establishments. Conversely, devices and/or operators in another gaming establishment may communicate with and/or control devices in casino 1705.

Here, gaming establishment 1797 is configured for communication with central system 1763, but is not configured for communication with other gaming establishments. Some gaming establishments (not shown) may not be in communication with other gaming establishments or with a central system. Gaming establishment 1705 includes multiple gaming machines 1721, each of which is part of a bank 1710 of gaming machines 1721. In this example, gaming establishment 1705 also includes a bank of networked gaming tables 1753. However, the present disclosure may be implemented in gaming establishments having any number of gaming machines, gaming tables, etc. It will be appreciated that many gaming establishments include hundreds or even thousands of gaming machines 1721 and/or gaming tables 1753, not all of which are necessarily included in a bank and some of which may not be connected to a network. At least some of gaming machines 1721 and/or mobile devices 1770 may be “thin clients” that are configured to perform client-side methods as described elsewhere herein.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 1753 may be configured for communication with individual player terminals (not shown), which may be configured to accept bets, present an electronic representation of a dealer, indicate game outcomes, etc.

Gaming establishment 1705 also includes networked kiosks 1777. Depending on the implementation, kiosks 1777 may be used for various purposes, including but not limited to cashing out, prize redemption, redeeming points from a player loyalty program, redeeming “cashless” indicia such as bonus tickets, smart cards, generating temporary IDs, creating new player tracking accounts based on temporary IDs, etc. In some implementations, kiosks 1777 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present disclosure. For example, in some implementations of the disclosure, kiosks 1777 may be configured to receive information from a patron, e.g., such as temporary IDs or account creation data.

In this example, each bank 1710 has a corresponding switch 1715, which may be a conventional bank switch in some implementations. Each switch 1715 is configured for communication with one or more devices in computer room 1720 via main network device 1725, which combines switching and routing functionality in this example. Although various communication protocols may be used, some implementations may use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various implementations of the disclosure. IGT has also developed a gaming-industry-specific transport layer called CASH that rides on top of TCP/IP and offers additional functionality and security.

Here, gaming establishment 1705 also includes an RFID network, implemented in part by RFID switches 1719 and multiple RFID readers 1717. An RFID network may be used, for example, to track objects (such as mobile gaming devices 1770, which include RFID tags 1727 in this example), patrons, etc., in the vicinity of gaming establishment 1705.

As noted elsewhere herein, some implementations of the disclosure may involve “smart” player loyalty instruments, such as player tracking cards, which include an RFID tag. Accordingly, the location of such RFID-enabled player loyalty instruments may be tracked via the RFID network. In this example, at least some of mobile devices 1770 may include an RFID tag 1727, which includes encoded identification information for the mobile device 1770. Accordingly, the locations of such tagged mobile devices 1770 may be tracked via the RFID network in gaming establishment 1705. Other location-detection devices and systems, such as the global positioning system (“GPS”), may be used to monitor the location of people and/or devices in the vicinity of gaming establishment 1705 or elsewhere.

Various alternative network topologies can be used to implement different implementations of the disclosure and/or to accommodate varying numbers of networked devices. For example, gaming establishments with large numbers of gaming machines 1721 may require multiple instances of some network devices (e.g., of main network device 1725, which combines switching and routing functionality in this example) and/or the inclusion of other network devices not shown in FIG. 17. Some implementations of the disclosure may include one or more middleware servers disposed between kiosks 1777, RFID switches 1719 and/or bank switches 1715 and one or more devices in computer room 1720 (e.g., a corresponding server). Such middleware servers can provide various useful functions, including but not limited to the filtering and/or aggregation of data received from switches, from individual gaming machines and from other devices. Some implementations of the disclosure include load-balancing methods and devices for managing network traffic. In some implementations, middleware servers may provide intermediate data handling and processing for implementing jackpot ladders 100—for example, a middleware server may collect wager contributions from several banks of gaming machines and forward them on to a jackpot ladder server or servers that administer a jackpot ladder 100. A jackpot ladder server or servers may provide functionality that allows for the configuration of a jackpot ladder progressive game, as well as for providing access to and managing such a progressive game.

The jackpot ladder server(s) may, for example, be configured to receive operator or manufacturer inputs that define various operating parameters, such as total desired jackpot RTPs, wager sizes, groupings, jackpot levels, seed values/RTPs, injection RTPs, jackpot odds, etc. that may be used to define a particular jackpot ladder. The jackpot ladder server may be configured, via software or hardware-encoded instructions, to process such input data according to the techniques outlined herein to provide other data, such as feed RTPs and monetary contributions for each jackpot level and grouping combination.

The jackpot ladder server(s), or other server(s) in the system, may also be configured to receive data from gaming machines offering games that have been designated as eligible to participate in a particular jackpot ladder. The received data may include information pertaining to wagers placed, and the jackpot ladder server(s) or other servers may be configured to divert, or cause to be diverted, portions of each such wager into the meters for the appropriate jackpot levels. The jackpot ladder server(s) or other server(s) may also be configured to determine whether a given wager is a winning wager for one or more of the jackpot levels in the grouping for that wager amount. If a jackpot is won, the jackpot server(s) or other server(s) may be configured to transfer the amount shown indicated by the meter for the won jackpot to the winning player, e.g., by providing a voucher or coupon indicating the winning, by direct deposit into a player account, or by some other mechanism. The jackpot server(s) or other server(s) may also be configured to reset the won jackpot meter after such a payout (as well as to load the meter with any seed value and perform any injection funding that is desired).

Storage devices 1711, sb™ server 1730, License Manager 1731, Arbiter 1733, servers 1732, 1734, 1736 and 1738, host device(s) 1760 and main network device 1725 are disposed within computer room 1720 of gaming establishment 1705. In practice, more or fewer devices may be used. Depending on the implementation, some such devices may reside in gaming establishment 1705 or elsewhere.

One or more devices in central system 1763 may also be configured to perform, at least in part, tasks specific to the present disclosure, such as the functions which may be performed by a jackpot ladder server. For example, one or more servers 1762, storage devices 1764 and/or host devices 1760 of central system 1763 may be configured to implement the functions described in detail elsewhere herein.

One or more of the servers of computer room 1720 may be configured with software for receiving a player's wager gaming notification parameters, determining when a wagering condition corresponds with the wager gaming notification parameters and/or providing a notification to the player when the wagering condition corresponds with the wager gaming notification parameters.

Other devices that may be deployed in network 1705 do not appear in FIG. 17. For example, some gaming networks may include not only various radio frequency identification (“RFID”) readers 1717, but also RFID switches, middleware servers, etc., some of which are not depicted in FIG. 17. These features may provide various functions. For example, a server (or another device) may determine a location of a mobile device 1770 according to the location of an RFID reader that reads an RFID tag 1727.

The servers and other devices indicated in FIG. 17 may be configured for communication with other devices in or outside of gaming establishment 1705, such as host devices 1760, kiosks 1777 and/or mobile devices 1770, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the disclosure provide one or more of these servers in the form of blade servers.

Some implementations of sb™ server 1730 and the other servers shown in FIG. 17 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the disclosure, many of these devices (including but not limited to License Manager 1731, servers 1732, 1734, 1736, and 1738, and main network device 1725) are mounted in a single rack with sb™ server 1730. Accordingly, many or all such devices will sometimes be referenced in the aggregate as an “sb™ server.” However, in alternative implementations, one or more of these devices is in communication with sb™ server 1730 and/or other devices of the network but located elsewhere. For example, some of the devices could be mounted in separate racks within computer room 1720 or located elsewhere on the network. Moreover, it can be advantageous to store large volumes of data elsewhere via a storage area network (“SAN”).

Computer room 1720 may include one or more operator consoles or other host devices that are configured for communication with other devices within and outside of computer room 1720. Such host devices may be provided with software, hardware and/or firmware for implementing various implementations of the disclosure. However, such host devices need not be located within computer room 1720. Wired host devices 1760 (which are desktop and laptop computers in this example) and wireless devices 1770 (which are PDAs in this example) may be located elsewhere in gaming establishment 1705 or at a remote location.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present disclosure should not be limited by any of the implementations described herein, but should be defined only in accordance with the following and later-submitted claims and their equivalents.

It will be understood that unless features in any of the above-described implementations are expressly identified as incompatible with one another or the surrounding context implies that they are mutually exclusive and not readily combinable in a complementary and/or supportive sense, the totality of this disclosure contemplates and envisions that specific features of those implementations can be selectively combined to provide one or more comprehensive, but slightly different, technical solutions. It will therefore be further appreciated that the above description has been given by way of example only and that modifications in detail may be made within the scope of the invention.

What is claimed is:

1. A method of providing a multi-stake, multi-level jackpot, the method comprising:
establishing a jackpot ladder with n jackpot levels;
establishing k groupings of jackpot levels within the n jackpot levels, wherein:
k is greater than 2 and less than n,
at least one of the k groupings of jackpot levels includes two or more of the n jackpot levels,
each grouping of jackpot levels is associated with a different wager size, and
at least two of the k groupings of jackpot levels associated with sequentially adjacent wager sizes have at least one jackpot level of the n jackpot levels in common; and
providing a display indicating the n jackpot levels and indicia indicating, based on which jackpot levels are in each of the k groupings, the wager size or sizes associated with each jackpot level.

2. The method of claim 1, wherein the jackpot levels within each grouping are contiguous.

3. The method of claim 1, wherein for each pair of adjacent groupings:
the grouping in the pair of groupings associated with a higher wager size includes at least one jackpot level that is higher in average expected jackpot size than the jackpot levels in the grouping in the pair of groupings associated with a lower wager size, and
the grouping in the pair of groupings associated with the lower wager size includes at least one jackpot level that is lower in average expected jackpot size than the jackpot levels in the grouping in the pair of groupings associated with the higher wager size.

4. The method of claim 1, wherein at least one of the k groupings includes a different number of jackpot levels than the other groupings.

5. The method of claim 1, wherein each pair of sequentially adjacent wager sizes have at least one jackpot level of the n jackpot levels in common.

6. The method of claim 1, wherein at least two of the k groupings of jackpot levels associated with sequentially adjacent wager sizes have at least two jackpot levels of the n jackpot levels in common.

7. The method of claim 1, wherein at least one of the jackpot levels is associated with three different groupings of the k groupings and, accordingly, three different wager sizes.

8. The method of claim 1, wherein wagers corresponding to any of the wager sizes associated, via the groupings, with a given jackpot level have substantially equal odds of winning the given jackpot level.

9. The method of claim 1, wherein a wager of a given wager size has a substantially equal chance of winning any of the jackpot levels in the grouping of jackpot levels associated with the given wager size.

10. The method of claim 1, wherein, for groupings including an identical number of jackpot levels, the jackpot levels in corresponding relative positions in each of the groupings have odds of winning that are the same and the odds of winning each jackpot level within any of the groupings are different between the jackpot levels.

11. The method of claim 1, wherein each jackpot level in each grouping has odds that vary between groupings.

12. The method of claim 1, wherein total return to player (RTP) for wagers placed at each wager size does not vary with wager size.

13. The method of claim 1, wherein total return to player (RTP) for wagers placed at each wager size increases with wager size.

14. The method of claim 1, wherein all of the groupings have at least one jackpot level of the n jackpot levels in common.

15. A method of providing a multi-stake, multi-level jackpot, the method comprising:
establishing:
a jackpot ladder with n jackpot levels;
k different wager amounts, where k is greater than 2 and less than n;
k groupings of jackpot levels, each grouping associated with a different one of the wager amounts;
odds of winning each jackpot level in each grouping;
a total jackpot return-to-player (RTP) associated with each grouping; and
n seed values, each seed value associated with a different jackpot level;
determining, for each grouping, a seed RTP for each jackpot level in the grouping based on the seed value associated with that jackpot level;
summing, for each grouping, the seed RTPs for each jackpot level in the grouping to produce a total seed RTP for the grouping;
determining, for each grouping, a total feed RTP by subtracting the total seed RTP, as well as any other non-feed RTPs associated with the jackpot levels in the grouping, from the total jackpot RTP for the grouping;
determining, for each grouping, a total seed amount by summing the seed values associated with the jackpot levels within the grouping;
selecting an initial grouping of the k groupings;
determining, for each jackpot level in the initial grouping, a feed RTP by multiplying the total feed RTP for the initial grouping by the seed value associated with the jackpot level and dividing by the total seed amount for the grouping;
for each jackpot level in groupings other than the initial grouping:
a) determining a feed RTP that has a previously-determined feed RTP associated with that jackpot level in a different grouping by multiplying that previously-determined feed RTP for that jackpot level by the wager size associated with the grouping for which the previously-determined feed RTP was determined and then dividing by the wager size associated with that jackpot level's grouping; and
b) selecting, for jackpot levels with feed RTPs not determinable via a), a feed RTP such that summing all of the feed RTPs associated with the jackpot levels within that jackpot level's grouping results in a summed amount that equals the total feed RTP for that jackpot level's grouping.

16. The method of claim 15, wherein the odds of winning each jackpot level in each grouping are substantially the same within each grouping and between groupings.

17. The method of claim 15, wherein the seed RTP associated with each jackpot level is apportioned between a “show now” amount and a “pre-growth” amount.

18. The method of claim 15, further comprising establishing an injection RTP for each wager size, wherein the total feed RTP for each grouping is determined by subtracting the total seed RTP, the injection RTP, as well as any other non-feed RTPs associated with the jackpot levels in the grouping, from the total jackpot RTP for the grouping.

19. The method of claim 15, further comprising:
determining a monetary contribution corresponding to each jackpot level in each grouping by multiplying the wager size associated with that grouping by the feed RTP for that jackpot level in that grouping;
receiving indications of wagers placed in wagering games that are eligible to participate in the jackpot ladder based on the wagering game and the wager size of the wager; and
contributing, for each wager received, an amount or amounts of that wager to meters for the jackpot levels in the grouping associated with the wager size of the wager, the amount or amounts contributed to each meter equal to the monetary contribution determined for the jackpot level for that meter in the grouping corresponding with the wager size.
